(19) United States
(12) Patent Application Publication
(10) Pub. No.: US 2020/0146781 A1
(43) Pub. Date: May 14, 2020

(54) RETENTIVE ORTHODONTIC DENTAL APPLIANCES AND METHODS OF MAKING SAME

(71) Applicant: Fred MURRELL, Toronto (CA)

(72) Inventor: Fred MURRELL, Toronto (CA)

(21) Appl. No.: 16/625,928

(22) PCT Filed: Jun. 26, 2018
(86) PCT No.: PCT/CA2018/050785

§ 371 Date: Dec. 23, 2019

Related U.S. Application Data
(60) Provisional application No. 62/524,971, filed on Jun. 26, 2017.

(51) Int. Cl. A61C 7/16; A61C 7/28

(52) U.S. Cl. CPC A61C 7/16; A61C 7/282

(57) ABSTRACT

The present invention relates to retentive orthodontic dental appliances and methods for making same. The retentive orthodontic dental appliances of the present invention comprise structures formed on, and/or in, the tooth abutting surfaces of the base portions thereof to facilitate the bonding of the appliances to the surface of teeth with an adhesive. In embodiments of the present invention, at least a portion of the base portions of the appliances is substantially permeable to air and substantially impermeable to adhesive and is configured to allow air to permeate through the base portion when the appliance is being adhered to the tooth.

### FIELD OF THE INVENTION

The present invention relates to retentive orthodontic dental appliances, and in particular, to retentive orthodontic dental appliances comprising structures formed on, and/or in, the tooth abutting surfaces of the base portions thereof to facilitate the bonding of the appliances to the surface of teeth with an adhesive.

### BACKGROUND OF THE INVENTION

Orthodontic treatment relates to the movement of misaligned teeth to desired positions in the oral cavity for cosmetic reasons and/or to improve the function of the jaw and teeth during mastication. In the field of orthodontics, it is known to adhere orthodontic appliances, such as brackets, buccal tubes and the like, directly to teeth. The appliances may be made of a variety of materials, including metallic materials (such as stainless steel and titanium), plastics (such as filled and/or reinforced polycarbonate), ceramics (such as monocrystalline and polycrystalline alumina), porcelain, glass or the like and are affixed to the teeth by cleaning the tooth and chemically bonding the appliances to a patient's teeth with a dental adhesive. In the case of orthodontic brackets, dental wire is threaded from bracket to bracket and tensioned appropriately. The tensioning of the dental archwire provides lateral forces on the teeth via the brackets so that over a period of time the teeth are gradually coerced into a desired alignment.

In order for an orthodontic appliance to perform its desired function, there must be a strong adhesive-tooth bond and a strong adhesive-appliance bond. Premature de-bonding of orthodontic appliances represents a nuisance to both the orthodontist and the patient. In some instances, the appliance may de-bond due to forces intentionally placed on the appliance by the orthodontist when attempting to move the underlying tooth to a desired position. In other instances, the appliance may de-bond due to the forces of mastication, such as when the patient bites into a relatively hard food object. If de-bonding occurs outside of the orthodontist's office, the tooth alignment process is interrupted and the patient must return to the office for an extra unscheduled office visit where the archwire is removed from all of the brackets and the surface of the tooth lacking the bracket is then cleaned in preparation for re-bonding. Unless the de-bonded bracket can be cleaned of old adhesive and reused, a new bracket is selected for attachment. As can be appreciated, such a procedure is time consuming and increases the expense and effort associated with orthodontic treatment.

The phenomena of bond failure between orthodontic appliances and the surfaces of associated teeth may arise at the location of the interface between the base of the bracket and the adhesive, in the adhesive itself, or at the interface between the adhesive and the tooth surface. Failure of the adhesive-tooth bond is rarely experienced; however, the bond between the appliance and the adhesive is found to fail quite often.

Certain methods of improving the adherence of orthodontic appliances to teeth are known in the art. For example, the bonding surface area of the base of the appliance may be roughened or scribed in order to increase the surface area of the bonding surface of the appliance in contact with the adhesive, thereby enhancing the chemical bond. Roughened surfaces may be provided by sandblasting the base or by attaching grit or other particles to the base. Examples of such brackets are described in, for example, U.S. Pat. Nos. 4,626,209 and 4,243,386.

Direct bonding may also be accomplished by using an appliance with a base having structures for forming a mechanical bond with the adhesive. For example, U.S. Pat. Nos. 3,765,091, 3,932,940 and 4,063,360 disclose base pads onto which an orthodontic appliance is mounted, wherein the base pads have a series of holes penetrating the entire thickness thereof allowing the adhesive to flow from the tooth abutting surface of the base pad, through the holes, and on to the outer surface of the base pad, thus forming a lock which holds the base pad and connected appliances to the dental surface. The adhesive cannot be immediately removed, because attempting to do so would move the appliance while the adhesive is setting, thereby negating the precise positioning required for orthodontic treatment. However, if the orthodontist waits to remove the excess adhesive from the appliance until the pad is reasonably securely bonded to the tooth, the adhesive has already bonded itself to the appliance and therefore difficult to remove. If excessively removed, the bond will be weakened. On the other hand, if excess adhesive is allowed to remain on the outer surface of the base pad, it may darken with age and/or stain from food and beverages, form food traps contributing to the formation of caries, lock the tie wing areas of the appliance and/or interfere with the archwires.

Some orthodontic appliances have a base with small undercut regions that contact the adhesive as the appliance base is embedded in the adhesive. Once the adhesive has hardened, the adhesive is mechanically interlocked to the undercuts of the base such that retention of the appliance on the tooth is improved. Examples of appliances having a base provided with undercut areas that may be formed in a machining operation are described in U.S. Design Pat. No. 290,040. Examples of appliances having bases with pegs or tabs presenting undercut areas are described in U.S. Design Pat. Nos. 340,523 and 5,393,486.

Methods of providing undercuts to a bonding surface such as those described above, include a method of forming undercuts by machining or the like as secondary work after manufacturing an orthodontic apparatus body. For example, orthodontic appliances have been manufactured by metal injection molding. With such a metal injection molding method however, since a mold is used for injection-molding, undercuts cannot be directly molded without carrying out the secondary work to the sintered body. According to the method of carrying out the afore-mentioned secondary work, as an orthodontic apparatus is generally relatively small, there are problems such as extremely complex working, inferior productivity and high cost. Moreover, if a strong metal such as titanium is used for orthodontic apparatuses, the workability is poor and undercuts are extremely hard to form.

It has also been known to attach bonding pads to appliances by welding, soldering, brazing or other procedures wherein the bonding pads have bonding surfaces of various types to produce the desired bond between the appliances and the teeth. For example, U.S. Pat. Nos. 4,068,379 and 4,165,561 disclose the use of a metal mesh welded or otherwise bonded to the bonding base of the appliance in order to provide acceptable mechanical bonding characteristics. However, such bonding or welding is subject to structural instability and such devices suffer from a weak attachment of the pad to the appliance as the welding or otherwise bonding of these various types of bonding surfaces to the appliance bases is subject to structural instability. In addition, the spot welds destroy the mesh structure at the points of attachment to the pad and/or the mesh portion is buried by brazing filler metal during welding, thereby decreasing the bonding force between the wire mesh and the body and thus decreasing the effectiveness of the adhesive in bonding the mesh to the tooth. Furthermore, the mesh is considered a significant factor in the manufacturing expense of orthodontic brackets, since such a manufacturing process often entails carefully cutting the mesh to shape, aligning the mesh with the bracket body, and the brazing the mesh to fix the mesh to the bracket body.

Another problem with known orthodontic appliances having structures on the bonding surface thereof for forming a mechanical bond with the adhesive is a tendency for air pockets to remain in the adhesive after application. As mentioned, many known appliance bases are fabricated to include holes, recesses and/or meshes in attempts to increase the bonding surface area of the appliance. However, it is difficult to apply the adhesive to expel air pockets adjacent to such surfaces in many appliances. For example, when pressed against a tooth surface, these base designs do not accommodate air pocket evacuation responsive to the compressive forces communicated through the bonding material due to a lack of open channels for the air to flow. Air pockets trapped within the adhesive may result in a weaker bond between orthodontic appliances and the surfaces of associated teeth and result in bond failure within the adhesive itself.

A need, therefore, exists for the development of an orthodontic appliance and a method for producing same that obviates or mitigates at least one of the disadvantages described above or that provides a useful alternative.

### SUMMARY OF THE INVENTION

The present invention provides retentive orthodontic dental appliances which substantially reduce the problems experienced with prior art orthodontic appliances.

The present invention provides retentive orthodontic dental appliances having at least one cavity and/or at least one projection formed in the tooth abutting surface of the base portion thereof wherein at least a portion of the base portion is substantially permeable to air and substantially impermeable to adhesive.

The present invention provides a method for forming an orthodontic dental appliance having at least one undercut in the tooth abutting surface of the base portion thereof by means of a simple process without the need for secondary work.

In accordance with an aspect of the present invention, there is provided an orthodontic appliance comprising: a base portion having a tooth abutting surface and an opposite outer surface, the tooth abutting surface for adhering to a tooth; a body portion extending from the base portion in a direction away from the outer surface; the base portion comprising at least one cavity.

In an embodiment, the body portion is for receiving an archwire.

In an embodiment, the at least one cavity is formed in the tooth abutting surface. In an embodiment, the at least one cavity is for accommodating an adhesive.

In an embodiment, the accommodation of the adhesive by the at least one cavity forms a lock between the appliance and the adhesive when the adhesive cures.

In an embodiment, the at least one cavity extends into the base portion away from the tooth abutting surface toward, but not through to, the opposite outer surface.

In an embodiment, at least a portion of the base portion is substantially permeable to air and substantially impermeable to the adhesive.

In an embodiment, the at least a portion of the base portion that is substantially permeable to air and substantially impermeable to adhesive is configured to allow air to permeate through the base portion when the appliance is being adhered to the tooth.

In an embodiment, the at least one cavity is a plurality of cavities.

In an embodiment, at least one cavity of the at least one cavity is blind. In another embodiment of the present invention, at least one cavity of the at least one cavity is not blind. However, regardless of whether or not a cavity is blind, the cavity permits the adhesive to enter into, but not pass through, the base portion to the outer surface.

In an embodiment, the at least one cavity is located near the centre of the base portion. This configuration may preserve as much unimpaired adhesion to the tooth of the entire area of the base portion as possible, to securely hold the central area of the base portion as well as the marginal portions.

In an embodiment, the at least one cavity is provided in the marginal portion of the base portion. In another embodiment of the present invention, the at least one cavity extends along at least one side of the base portion. In the case of orthodontic brackets, these embodiments may locate the extra holding power generally as far as possible from the brackets so they can most effectively resist tipping forces applied to the base through the brackets by the arch wire.

The cavities may take a variety of shapes and configurations so long as they do not substantially offset the structural integrity of the appliance. The cavities may be in the form of any regular or irregular shape known to persons skilled in this art, including geometric shapes such as polygons, polyhedrons and tetrahedrons, for example, but not limited to, circles, ellipses, squares, triangles, rectangles, pentagons, cubes, pyramids, ellipsoids, spheres, cones, stars, diamonds or the like. Arrangements, including grooves, slots, pores, pockets, openings, holes, indentations, recesses and/or perforations, including mesh, screen, web or woven interstitial space configurations, come within the meaning of “cavity” or “cavities” as those terms are used herein. Lines or grooves may either be straight, curved or irregularly shaped. Regardless of the shape however, the cavities extend into the thickness of the base portion, but as mentioned, do not protrude through the base portion on to the exposed front surface.

In an embodiment, the at least one cavity is in the form of a round pockets.

In an embodiment, the at least one cavity is in the form of a square pocket.

In an embodiment, the at least one cavity is in the form of a rectangular pocket.

In an embodiment, the at least one cavity is in the form of a cylindrical recess.

In an embodiment, the at least one cavity is in the form of a bulb-like recess.

In an embodiment, the cavities are in the form of parallel recesses, such as, for example, shaped like the dove-tails used in carpentry.

In an embodiment, the at least one cavity is in the form of a circular cone. In an embodiment, the apex of the circular cone is adjacent to the front face of the base portion.

In an embodiment, the at least one cavity is in the form of a circular cone. In an embodiment, the apex of the circular cone is adjacent to the front face of the base portion.

In an embodiment, the at least one cavity defines a wide, shallow profile.

In an embodiment, the plurality of cavities are aligned uniformly.

In an embodiment, the plurality of cavities are differently aligned in groups.

In an embodiment, two or more cavities of the plurality of cavities which are different from one another, are combined to form a group.

In an embodiment, the plurality of cavities are arranged in at least one row.

In an embodiment, the plurality of cavities are arranged in at least two parallel rows.

In an embodiment, the plurality of cavities are arranged in a waffle-like pattern.

In an embodiment, the plurality of cavities are not formed in rows but are staggered or arranged in another type of pattern.

In an embodiment, the at least one cavity is in the form of at least one groove or slot.

In an embodiment, the at least one groove or slot extends longitudinally across the tooth abutting surface of the appliance. In another embodiment of the present invention, the at least one groove or slot extends horizontally across the tooth abutting surface.

In an embodiment, the plurality of cavities are in the form of a series of parallel vertical or horizontal grooves or slots. In an embodiment, the grooves or slots are rectangular, square or V-shaped. In an embodiment, the grooves or slots are angled. In an embodiment, the grooves or slots opposite the vertical or horizontal midline are slanted outwardly or diverging. Such a configuration may provide a maximum area of tooth surface area exposed to the adhesive between the bonding surface and the tooth.

In an embodiment, the plurality of cavities are a plurality of spaced, radially contoured indentations. In an embodiment, the indentations define a circular shaped periphery in the tooth abutting surface. In another embodiment of the present invention, the indentations are formed with a different shaped periphery, such as, for example, an oval.

In an embodiment, the plurality of cavities are closely spaced to one another so as to leave narrow transitional areas therebetween in comparison to the width of each of the cavities.

In an embodiment, the cavities are approximately about 0.005 to about 0.040 inches in diameter.

In an embodiment, the cavities are approximately about 0.005 to about 0.015 inches in diameter.

In an embodiment, the cavities are approximately about 0.020 to 0.040 inches in diameter.

In an embodiment, the cavities may be centered approximately about 0.020 to 0.040 inches apart.

In an embodiment, the cavities may be about 0.012 inches in diameter and centered about 0.020 inches apart.

In an embodiment, the plurality of cavities are in the form of a mesh that resembles a miniature screen made of a number of interwoven, fine wires.

In an embodiment, the plurality of cavities are in the form of a lattice. In an embodiment, the configuration of the lattice is selected from a random orientation, a uniform orientation or a combination thereof. In an embodiment, the lattice is in the form of a round mesh, a square mesh or a combination thereof. In an embodiment, the lattice structure may have a thickness of about 0.010 inches.

As discussed above, the at least one cavity extends from the rear tooth abutting surface of the base portion into the thickness of the base portion toward the exposed front surface of the base portion, such that the at least one cavity extends a distance beyond the opening of the at least one cavity at the tooth abutting surface but not protruding all the way through, the exposed front surface of the base portion.

The at least one cavity provides varying degrees of porosity to the base portion by which the adhesive can permeate into the base portion. In an embodiment, the base portion is substantially porous to adhesive. As used herein, “substantially porous” denotes a base portion that is partially porous or completely porous to adhesive.

The distance that the at least one cavity extends into the base may vary in accordance to the desired amount of mechanical bonding desired. In one embodiment, the greater the depth of the cavities, the greater the holding power may be since the total side area (length times depth of the side walls) may determine the total strength of the bond.

In embodiments wherein the at least one cavity is a plurality of cavities, each cavity of the plurality of cavities may extend into the base portion by substantially the same distance. Alternatively, each cavity of the plurality of cavities may extend into the base portion by substantially different distances. Further alternatively, some cavities of the plurality of cavities may extend into the base portion by substantially the same distance while other cavities of the plurality of cavities may extend into the base portion by substantially different distances.

In an embodiment, the base portion may be from about 0.010 inches to about 0.030 inches thick.

In an embodiment, the base portion may be from about 0.006 inches to about 0.012 inches thick.

In an embodiment, the cavities extend into the thickness of the base portion approximately two thirds.

In an embodiment, the cavities penetrate into the base portion approximately about 0.008 to about 0.009 inches deep. For example, in the case where a base portion of 0.012 inches is employed, the maximum practical depth the cavities may be 0.009 inches.

In an embodiment, the cavities are square or rectangular shaped and are approximately from about 0.005 to about 0.015 inches in size along at least one side, and approximately about 0.005 inches deep at the center.

In an embodiment, about 80 to about 120 cavities are provided per cm² of tooth abutting surface area in the base portion.

In an embodiment, the cavities may be interconnected by pores or tunnels that extend through the interior of the base or by open channels that lie along the exterior surface of the tooth abutting surface of the base.

The cavities may be formed by any method known by persons skilled in this art. In some embodiments, the cavities may be formed by casting, drilling, chemical etching or the like.

In some embodiments, the at least one cavity formed in the rear tooth abutting surface of the base portion forms at least one protrusion, peg, projection and/or overhanging portion. The at least one protrusion, peg, projection and/or overhanging portion has a root or stem section having a base integrally formed with the tooth abutting surface and a head or apex section buccolingually extending from the root/stem section. As may be appreciated, each protrusion, peg, projection and/or overhanging portion may, on its own, present an undercut, or may be further deformed at its outer extremity, thereby forming an undercut, proximate the outer extremity, which undercut which is adapted to receive adhesive, that once cures or hardens, forms a mechanical bond or interlock between the appliance and the adhesive.

The terms “projection”, “protrusion”, “peg”, “projection” and “overhanging portion”, as used herein refer to any structure which extends outwardly from the tooth abutting surface of the base portion of the orthodontic appliance. The at least one projection may take a variety of shapes and configurations so long as it does not substantially offset the structural integrity of the appliance. The at least one projection may be in the form of any regular or irregular shape known to persons skilled in this art. In some embodiments, the at least one projection is in the shape of a square, a rectangle, a circle, an oval, an ellipse, a polygon, a trapezoid, a rhomboid, a diamond, a star and the like. In some embodiments, the at least one projection is T-shaped, L-shaped, hook-shaped and the like.

In some embodiments, the at least one projection is a plurality of projections.

Non-limiting examples of the projections include solid posts, hollow tubular posts, bristles, ridges, or combinations thereof. A few more detailed non-limiting examples include ridges in the form of concentric circles, squares, triangles or rectangles; solid posts or hollow tubular posts or projections in the form of circles, rectangles or triangles; a nonintersecting single continuous ridge such as a spiral or serpentine zig-zag; plural nonintersecting ridges such as a basket-weave pattern, or parallel or randomly aligned ridges; plural or intersecting ridges which intersect to form a grid-like pattern, maze or random orientation; and brush-like bristles.

In an embodiment, the projections have a head larger than the stem, i.e., larger in cross-sectional area at its outer, lingual end (apex) relative to its base.

In an embodiment, the projections are mushroom-shaped.

In an embodiment, the projections have a square cross-sectional configuration. In other embodiments, the projections have other shapes such as cylindrical or rectangular-shapes.

In an embodiment, the projections are arranged in a grid-like array.

In an embodiment, the projections are oriented in the same direction.

In an embodiment, the projections are oriented in different directions.

In an embodiment, all the projections in one row are identical with the other and mirror-images with the projections of the neighbouring row or the two neighboring rows.

In an embodiment, the plurality of projections is off-set.

In an embodiment, the projections comprise side portions oriented such that tangents thereto are transverse to the lateral and longitudinal axes of the base, i.e., such side portions are, upon application of the base to a tooth, neither parallel nor perpendicular to the gingivally directed masticatory forces.

In an embodiment, the height of each projection in a lingual direction is identical such that the outer edges of the projections lie in a curved reference plane that is identical in contour, but slightly spaced from, the curved tooth abutting surface.

In an embodiment, the projections do not project more than about 0.0197 inches out from the tooth abutting surface.

In an embodiment, the projections do not project more than about 0.080 inches out from the tooth abutting surface.

In an embodiment, the projections do not project more than about 0.118 inches out from the tooth abutting surface.

In an embodiment, the projections have a length of from about 0.005 inches to about 0.040 inches.

In an embodiment, the projections have a length of from about 0.020 inches to about 0.040 inches.

In an embodiment, the projections have a length of from about 0.005 inches to about 0.015 inches.

In an embodiment, where the projections are, for example, substantially square shaped, the side length may be about 0.020 inches and the distance between projections may be about 0.020 inches.

In an embodiment, where the projections are, for example, substantially square shaped, the side length may be about 0.010 inches and the minimum distance between projections may be about 0.010 inches.

In an embodiment, the undercut angle of the projections may be from about 10° to about 50°.

In an embodiment, the undercut angle of the projections may be from about 15° to about 50°.

In an embodiment, the undercut angle of the projections may be from about 15° to about 45°.

In an embodiment, the tooth abutting surface comprises side rails along the mesial and distal edges thereof which project a preselected distance from the tooth abutting surface. In some embodiments, the side rails project from the tooth abutting surface below the projections. In some embodiments, the side rails project from the tooth abutting surface equal the projections. In some embodiments, the side rails project from the tooth abutting surface past the projections. In some embodiments, the side rails extend the distance of about 0.012 inches and the projections extend the distance of about 0.08 inches. In some embodiments, the side rails may have a width of about 0.015 inches. In some embodiments, the side rails may comprise rounded edges or chamfered edges.

In an embodiment, the tooth abutting surface comprises a rim that extends around the periphery of the base portion and surrounds the projections. In some embodiments, the rim has a height in a lingual direction (as measured from the surface) that is less than the lingual height of the projections. In some embodiments, the rim has a height in a lingual direction (as measured from the surface) that is equal to the lingual height of the projections. In some embodiments, the rim has a height in a lingual direction (as measured from the surface) that is greater than the lingual height of the projections.

As discussed, at least a portion of the base portion is selectively permeable or semi-permeable in that it is substantially permeable to air and substantially impermeable to adhesive. In embodiments of the present invention, the at least a portion of the base portion that is selectively permeable or semi-permeable may be porous to air but also impermeable to adhesive due to its surface structure. In embodiments of the present invention, the at least a portion of the base portion that is selectively permeable or semi-permeable, at the molecular level can allow molecules of air to pass through, but not adhesive molecules. In embodiments of the present invention, the at least a portion of the base portion that is selectively permeable or semi-permeable may comprise a selectively permeable or semi-permeable membrane.

In embodiments of the present invention, the at least a portion of the base portion that is selectively permeable or semi-permeable may comprise any selectively permeable or semi-permeable material known to persons skilled in this art which is substantially permeable to air and substantially impermeable to adhesive. In embodiments of the present invention, the at least a portion of the base portion that is selectively permeable or semi-permeable may be composed of silicone; rubbers; elastomers; cork; ceramics; polyethylene (PE) such as, for example, but not limited to, high density spun-bound polyethylene similar to that sold under the name Tyvek™; polypropylene (PP) such as, for example, but not limited to, spun-bonded polypropylene fiber similar to that sold under the name Typar™; microperforated polyethylene similar to that sold under the name Rufco-Wrap™; polytetrafluoroethylene (PTFE or Teflon™) such as, for example, but not limited to, stretched polytetrafluoroethylene similar to that sold under the name Gore-Tex™; a silanized alumina; a molecular sieve material such as, for example, but not limited to, zeolites (aluminosilicate minerals), porous glass, active carbon, and clays; and a hydrophobic aerogel such as, for example, but not limited to, those based on silica, alumina, chromia, titania, zirconia, vanadia, samaria, holmia, erbia, carbon, cadmium selenide quantum dots, metal oxides such as, for example, but not limited to, aluminum oxide, tin dioxide, iron oxide, neodymium oxide, organic polymers such as, for example, but not limited to, agar or cellulose, and chalcogens (chalcogel) such as, for example, but not limited to, sulfur, selenium and other elements.

The portion of the base portion that is substantially permeable to air and substantially impermeable to adhesive functions as at least one “vent” to enable air trapped in air pockets within the adhesive to escape. The at least one vent, while enabling air to move through at least a portion of the base portion, hinders or prevents movement of the adhesive through the base portion as the appliance is placed on the tooth surface, such that the necessity of clean-up of adhesive near the front surface of the base portion is avoided.

In embodiments of the present invention, the at least one vent is connected in fluid communication with the at least one cavity. The at least one vent allows at least some of the air trapped in the adhesive to escape the adhesive and the appliance upon pressure application of the appliance against the adhesive and the tooth surface thereby facilitating the release of at least some of the air trapped within the adhesive under a relatively low application of pressure. The numbers and diameters and cross-sectional shapes of the at least one vent may be suitably determined depending on the volume and shape of the at least one cavity and the appliance itself. More than one vent may be provided. In embodiments of the present invention, the at least one vent is defined by a conventional lost wax casting process (also called “investment casting”, “precision casting”, or cire perdue) or the like. In embodiments of the present invention, the at least one vent opens to the exterior of the appliance. The at least one vent need not open to the exterior of the appliance but may open to the at least one adjacent cavity.

In an embodiment, the base portion comprises a single vent which is substantially permeable to air but substantially impermeable to adhesive.

In an embodiment, the base portion comprises enough vents to result in substantially the entire base portion substantially permeable to air but substantially impermeable to adhesive.

In an embodiment, the portion of the base portion that is substantially permeable to air and substantially impermeable to adhesive is comprised of a material that is substantially permeable to air and substantially impermeable to adhesive.

In an embodiment, the portion of the base portion that is substantially permeable to air is at least one passageway that extends from said tooth abutting surface to said opposite surface.

In an embodiment, the least one passageway is located in said at least one cavity.

In an embodiment, the at least one passageway includes at least one tapered portion that decreases in cross-sectional area as said outer surface is approached.

In an embodiment, the at least one passageway is tortuous.

In an embodiment, the at least one passageway contains an element extending in the at least one passageway that is substantially permeable to air and substantially impermeable to adhesive.

In an embodiment, the element closes at least a portion of the at least one passageway.

In an embodiment, the element is fixed in the at least one passageway.

In an embodiment, the at least one passageway also extends through the body portion.

In In an embodiment, the at least one passageway extends through a central portion of the body portion.

In an embodiment, the at least one passageway is a plurality of passageways.

In an embodiment, the at least one passageway comprises at least one additional passageway extending at an angle relative to the direction of extension of the at least one passageway wherein the at least one additional passageway is substantially permeable to air and substantially impermeable to adhesive.

In an embodiment, the at least one additional passageway extends in a direction perpendicular to the direction of extension of the at least one passageway.

In an embodiment, the bond strength of the appliance may be further enhanced by using a variety of different methods, such as by providing additional undercut regions and/or by increasing the surface area of the tooth abutting surface to enhance mechanical bonding of the appliance to a tooth surface using a dental adhesive.

In an embodiment, the surfaces of the protrusions and/or the surfaces of the walls within the cavities may be provided with irregularities, textured or may be sufficiently roughened such as by sandblasting or by etching with a chemical etchant or with a laser etching apparatus, to further facilitate a locking relationship with the adhesive.

Clinically acceptable shear bond strength (SBS) values are typically between about 5.9 to about 7-8 MPa. The adhesives Transbond XT and the self-etching adhesives Xeno V and Transbond Plus have been determined to provide SBSs of 15.49 MPa, 13.51 MPa and 11.57 MPa, respectively.

In an embodiment, the tooth abutting surface may be given a plasma treatment to provide a thin surface portion that enhances the adhesion of the adhesive—often giving more than 10 times the adhesion of the same material untreated. This is not a coating but a treatment that rearranges the molecular structure of the tooth abutting surface.

In an embodiment, the tooth abutting surface may be provided with a layer of particles. In some embodiments, the particles have a uniform size and/or shape. In some embodiments, the particles have non-uniform size and/or shape. In some embodiments, the particles are spheres, shards, rods and/cubes. In some embodiments, the particles are made of metal or ceramic. In some embodiments, the tooth abutting surface is provided with a substantially monolayer of substantially uniform sized particles having a size in the range of about 5 to about 200 microns to further enhance the adhesion. In an embodiment, the particles comprise substantially spherical hollow balls made of zirconium oxide.

In an embodiment, the bond strength of the appliance may be further enhanced by deforming the projections in the lateral direction.

In an embodiment, the tooth abutting surface may be coated with a primer or other composition that serves to enhance the bond between the orthodontic adhesive and the appliance.

A standard metal bracket may have a bond strength of about 150 kg/cm². When the appliance of the present invention is made of metal, in combination with the adhesive used, an exceptionally high bond strength, of the order of 1200-1550 psi (dependent upon bracket size, type and adhesive type), is obtained, which is very suitable for heavy wiring techniques.

In an embodiment, the entire orthodontic appliance is produced as a single element unitary body with at least one cavity and/or at least one projection preformed into the tooth abutting surface of the base portion. Provision of an orthodontic bracket as an integral unit may provide a small, strong, structurally more sound and accurately reproduced appliance at low cost.

The present invention is also useful for orthodontic appliances other than brackets. For example, the appliance may be a buccal tube, a cleat, a lingual button or other device that is directly bonded to a tooth surface. Such a device may include an open or closed slot for receiving an archwire, and the slot may have a round, rectangular or square cross-sectional configuration. The appliance may have tiewings or other structure (such as movable walls) to secure the archwire in the slot.

The orthodontic appliances of the present invention provide a stronger bond between the appliance and the adhesive. Providing a stronger bond between the appliance and the adhesive may prevent the appliances from separating from the tooth and correspondingly reduce unnecessary visits to the orthodontist. The stronger bond may also make it possible to apply more force to the tooth through the appliance for the orthodontic treatment. Therefore, the purpose of the present invention is to improve the bond between the adhesive layer and the appliance by improving the adhesive-appliance mechanical bond.

The orthodontic appliances of the present invention further permit adhesive material to spread relatively evenly and evacuate air pockets through the base/bonding material interface when the appliance is coated with bonding material and pressed against a tooth surface, thus reducing the likelihood of detachment.

The retentive orthodontic appliances and the methods for producing the same described herein overcome the shortcomings of the prior art appliances described above.

Further novel and inventive features of the present invention will become apparent to those of skill in the art upon examination of the following detailed description of the present invention. It should be understood, however, that the detailed description of the present invention and the specific examples presented, while indicating certain aspects of the present invention, are provided for illustration purposes only because various changes and modifications within the spirit and scope of the invention will become apparent to those of skill in the art from the detailed description of the invention and claims that follow.

### BRIEF DESCRIPTION OF THE DRAWINGS

The present invention will be further understood from the following description with reference to the Figures, in which:

FIG. 1A shows a perspective view of the front surface of an orthodontic bracket of the present invention.

FIG. 1B shows a perspective view of the tooth abutting surface of an orthodontic bracket of FIG. 1A.

FIG. 2A shows an exploded view of the tooth abutting surface of an orthodontic bracket of the present invention.

FIG. 2B shows a cross-sectional view of the tooth abutting surface of the orthodontic bracket of FIG. 2A.

FIG. 3A shows an exploded view of the tooth abutting surface of an orthodontic bracket of the present invention.

FIG. 3B shows a cross-sectional view of the tooth abutting surface of the orthodontic bracket of FIG. 3A.

FIG. 4A shows an exploded view of the tooth abutting surface of an orthodontic bracket of the present invention.

FIG. 4B shows a cross-sectional view of the tooth abutting surface of the orthodontic bracket of FIG. 4A.

FIG. 5A shows an exploded view of the tooth abutting surface of an orthodontic bracket of the present invention.

FIG. 5B shows a cross-sectional view of the tooth abutting surface of the orthodontic bracket of FIG. 5A.

FIG. 6A shows an exploded view of the tooth abutting surface of an orthodontic bracket of the present invention.

FIG. 6B shows a cross-sectional view of the tooth abutting surface of the orthodontic bracket of FIG. 6A.

FIG. 7 shows a cross-sectional view of the tooth abutting surface of an orthodontic bracket of the present invention.

FIG. 8A shows an exploded view of the tooth abutting surface of an orthodontic bracket of the present invention.

FIG. 8B shows a cross-sectional view of the tooth abutting surface of the orthodontic bracket of FIG. 8A.

FIG. 9A shows an exploded view of the tooth abutting surface of an orthodontic bracket of the present invention.

FIG. 9B shows a cross-sectional view of the tooth abutting surface of the orthodontic bracket of FIG. 9A.

FIG. 10A shows a perspective view of the tooth abutting surface of an orthodontic bracket of the present invention.

FIG. 10B shows a perspective view of the tooth abutting surface of an orthodontic bracket of the present invention.

FIG. 11A shows a perspective view of the tooth abutting surface of an orthodontic bracket of the present invention.

FIG. 11B shows a perspective view of the tooth abutting surface of an orthodontic bracket of the present invention.

FIG. 12A shows a perspective view of the tooth abutting surface of an orthodontic bracket of the present invention.

FIG. 12B shows a perspective view of the tooth abutting surface of an orthodontic bracket of the present invention.

FIG. 13A shows a perspective view of the tooth abutting surface of an orthodontic bracket of the present invention.

FIG. 13B shows a perspective view of the tooth abutting surface of an orthodontic bracket of the present invention.

FIG. 14A shows a front view of the tooth abutting surface of an orthodontic bracket of the present invention.

FIG. 14B shows a cross-sectional view of an orthodontic bracket of the present invention.

FIG. 15A shows a cross-sectional view of an orthodontic bracket of the present invention.

FIG. 15B shows a cross-sectional view of an orthodontic bracket of the present invention.

FIG. 16 shows a perspective view of the tooth abutting surface of an orthodontic bracket of the present invention.

FIG. 17A shows a perspective view of the tooth abutting surface of an orthodontic bracket of the present invention.

FIG. 17B shows a perspective view of the tooth abutting surface of an orthodontic bracket of the present invention.

FIG. 18A shows a cross-sectional view of an orthodontic bracket of the present invention.

FIG. 18B shows a perspective view of the front surface of an orthodontic bracket of the present invention.

FIG. 19A shows a perspective view of the front surface of an orthodontic bracket of the present invention.

FIG. 19B shows a cross-sectional view of an orthodontic bracket of the present invention.

FIG. 20A shows a cross-sectional view of an orthodontic bracket of the present invention.

FIG. 20B shows a cross-sectional view of an orthodontic bracket of the present invention.

FIG. 21A shows a cross-sectional view of an orthodontic bracket of the present invention.

FIG. 21B shows a cross-sectional view of an orthodontic bracket of the present invention.

FIG. 22A shows a cross-sectional view of an orthodontic bracket of the present invention.

FIG. 22B shows a cross-sectional view of the tooth abutting surface of an orthodontic bracket of the present invention.

FIG. 23A shows a cross-sectional view of an orthodontic bracket of the present invention.

FIG. 23B shows a cross-sectional view of the tooth abutting surface of an orthodontic bracket of the present invention.

FIG. 24A shows a cross-sectional view of the tooth abutting surface of an orthodontic bracket of the present invention.

FIG. 24B shows a cross-sectional view of the tooth abutting surface of an orthodontic bracket of the present invention.

FIG. 24C shows a cross-sectional view of the tooth abutting surface of an orthodontic bracket of the present invention.

FIG. 25A shows a cross-sectional view of the tooth abutting surface of an orthodontic bracket of the present invention.

FIG. 25B shows a cross-sectional view of the tooth abutting surface of an orthodontic bracket of the present invention.

FIG. 25C shows a cross-sectional view of the tooth abutting surface of an orthodontic bracket of the present invention.

FIG. 26A shows a cross-sectional view of the tooth abutting surface of an orthodontic bracket of the present invention.

FIG. 26B shows a cross-sectional view of the tooth abutting surface of an orthodontic bracket of the present invention.

FIG. 26C shows a cross-sectional view of the tooth abutting surface of an orthodontic bracket of the present invention.

FIG. 27A shows a cross-sectional view of the tooth abutting surface of an orthodontic bracket of the present invention.

FIG. 27B shows a cross-sectional view of the tooth abutting surface of an orthodontic bracket of the present invention.

FIG. 27C shows a cross-sectional view of the tooth abutting surface of an orthodontic bracket of the present invention.

FIG. 28A shows a cross-sectional view of the tooth abutting surface of an orthodontic bracket of the present invention.

FIG. 28B shows a cross-sectional view of the tooth abutting surface of an orthodontic bracket of the present invention.

FIG. 28C shows a cross-sectional view of the tooth abutting surface of an orthodontic bracket of the present invention.

FIG. 29A shows a cross-sectional view of the tooth abutting surface of an orthodontic bracket of the present invention.

FIG. 29B shows a cross-sectional view of the tooth abutting surface of an orthodontic bracket of the present invention.

FIG. 30A shows a cross-sectional view of the tooth abutting surface of an orthodontic bracket of the present invention.

FIG. 30B shows a cross-sectional view of the tooth abutting surface of an orthodontic bracket of the present invention.

FIG. 31A shows a front view of the tooth abutting surface of an orthodontic bracket of the present invention.

FIG. 31B shows a front view of the tooth abutting surface of an orthodontic bracket of the present invention.

FIG. 32A shows a front view of the tooth abutting surface of an orthodontic bracket of the present invention.

FIG. 32B shows a front view of the tooth abutting surface of an orthodontic bracket of the present invention.

FIG. 33A shows a front view of the tooth abutting surface of an orthodontic bracket of the present invention.

FIG. 33B shows a front view of the tooth abutting surface of an orthodontic bracket of the present invention.

FIG. 34A shows a front view of a portion of the tooth abutting surface of an orthodontic bracket of the present invention.

FIG. 34B shows a front view of a portion of the tooth abutting surface of an orthodontic bracket of the present invention.

FIG. 35A shows a front view of a portion of the tooth abutting surface of an orthodontic bracket of the present invention.

FIG. 35B shows a front view of a portion of the tooth abutting surface of an orthodontic bracket of the present invention.

FIG. 36A shows a front view of the tooth abutting surface of an orthodontic bracket of the present invention.

FIG. 36B shows a front view of the tooth abutting surface of an orthodontic bracket of the present invention.

FIG. 37A shows a front view of the tooth abutting surface of an orthodontic bracket of the present invention.

FIG. 37B shows a front view of the tooth abutting surface of an orthodontic bracket of the present invention.

FIG. 38 shows a perspective exploded view of a portion of the tooth abutting surface of an orthodontic bracket of the present invention.

### DETAILED DESCRIPTION OF CERTAIN ASPECTS

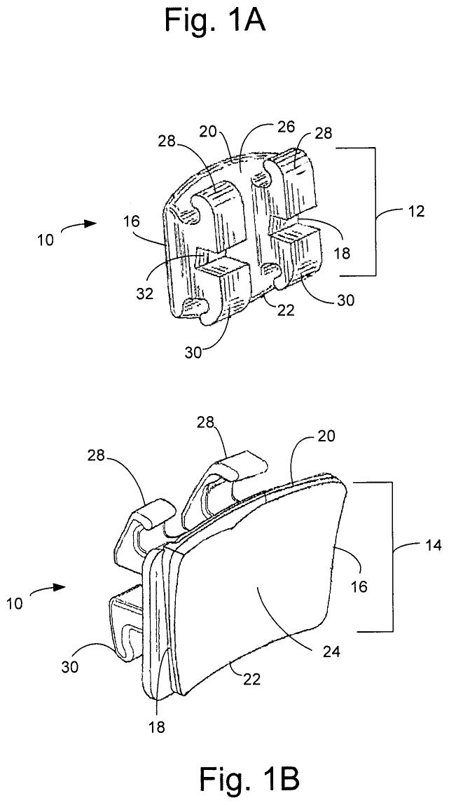

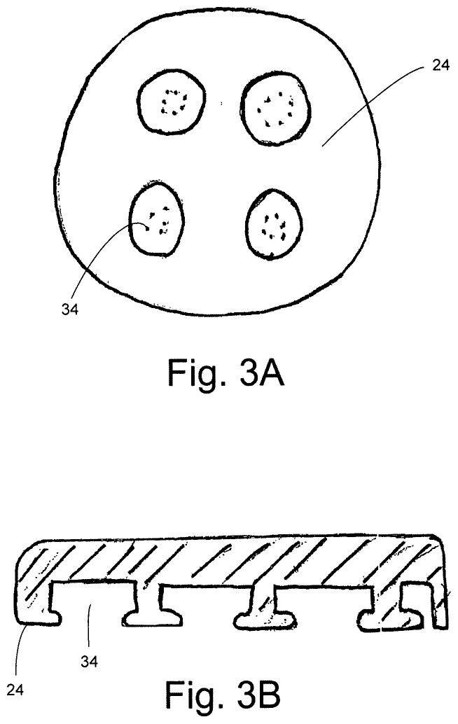

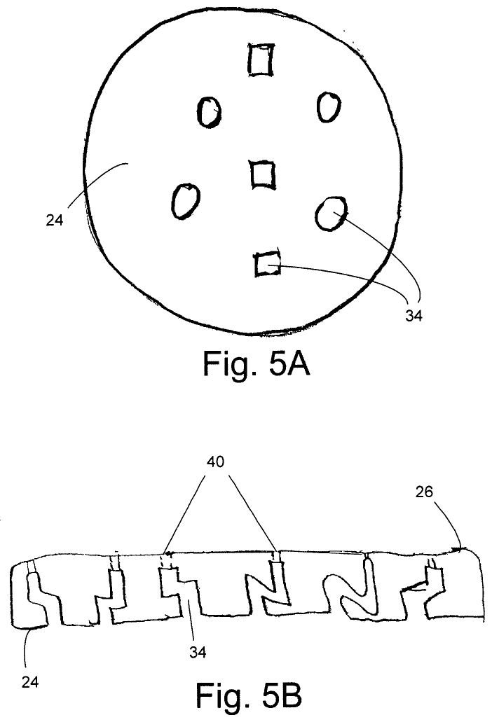

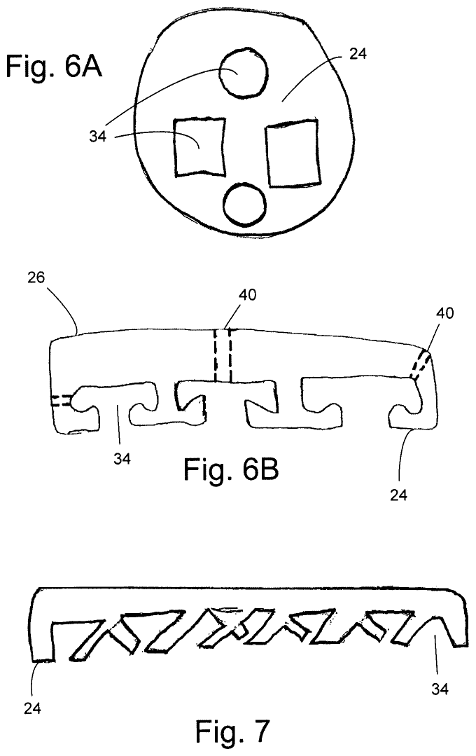

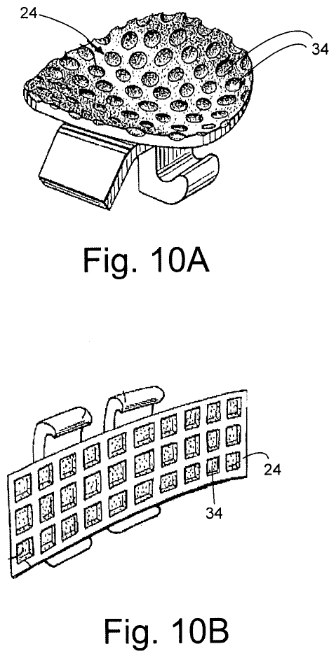

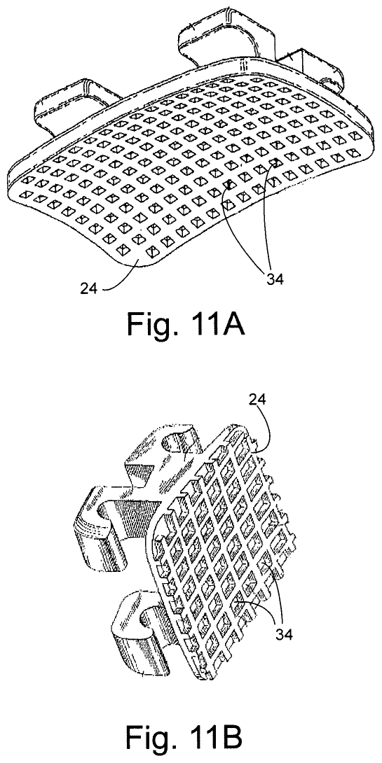

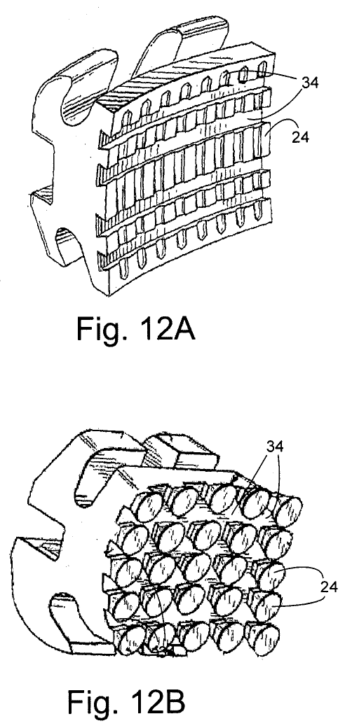

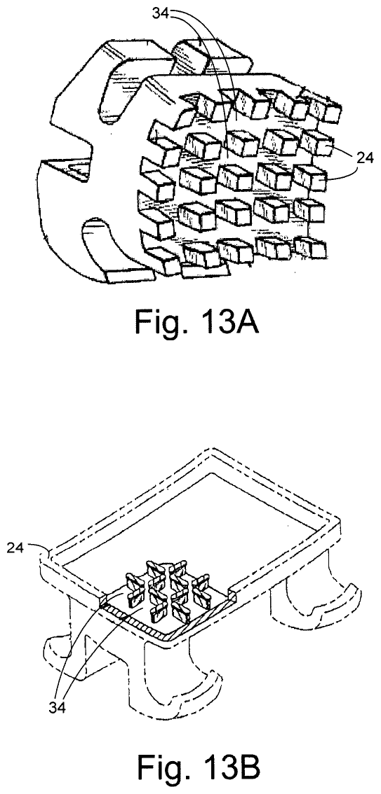

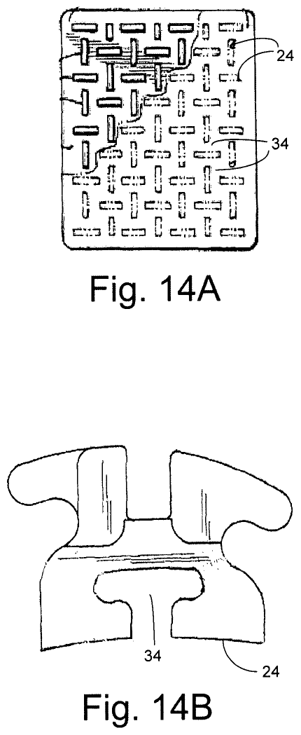

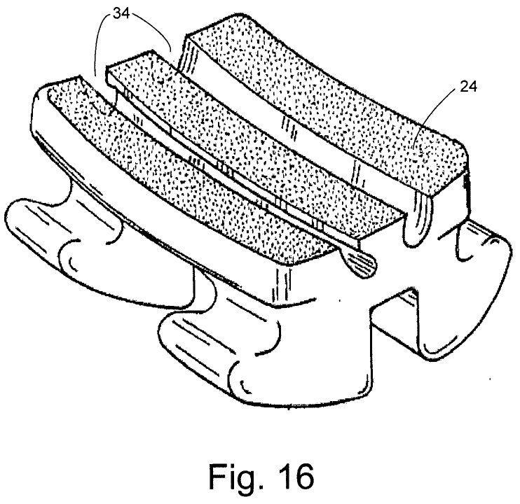

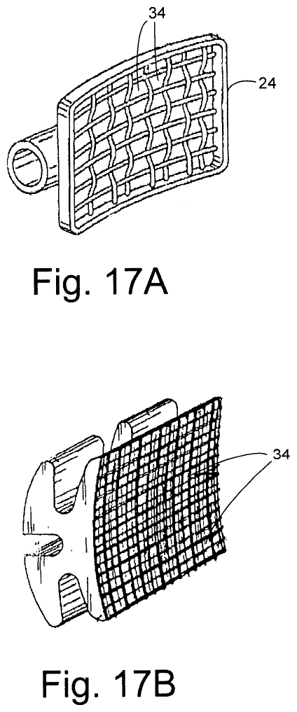

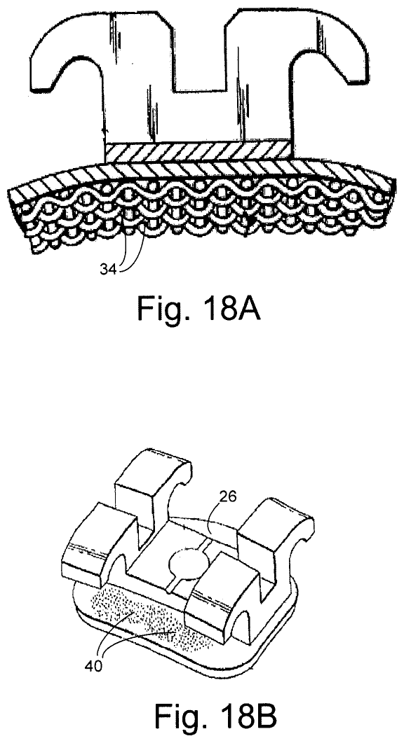

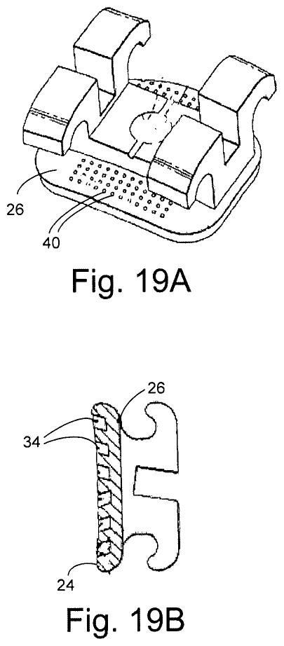

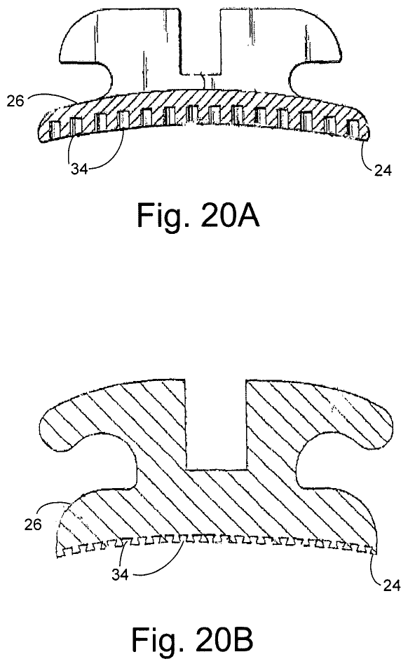

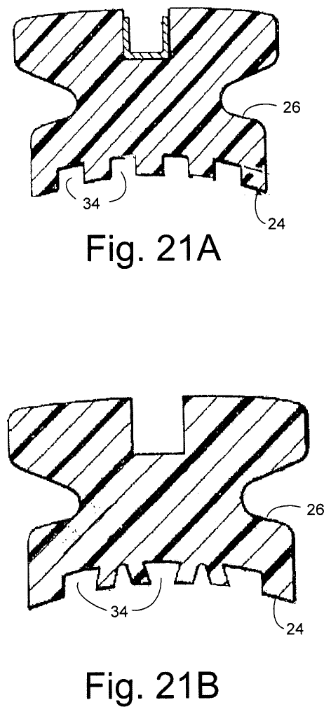

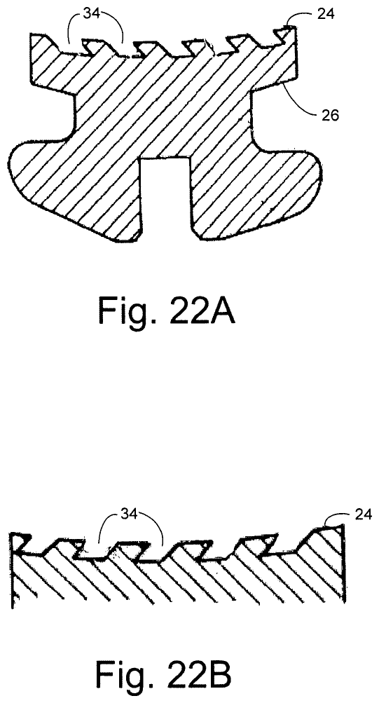

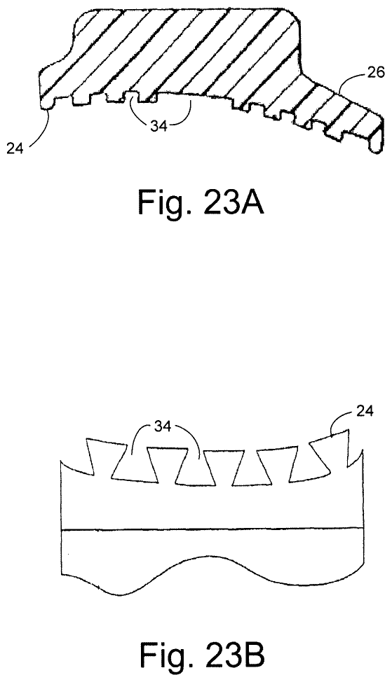

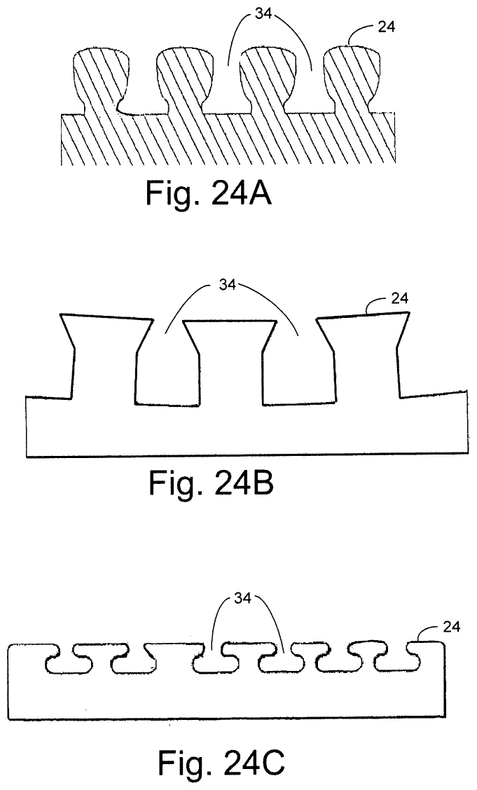

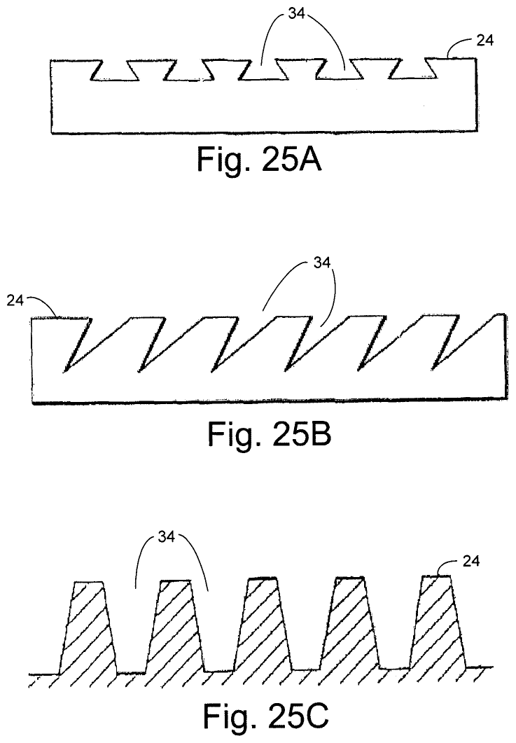

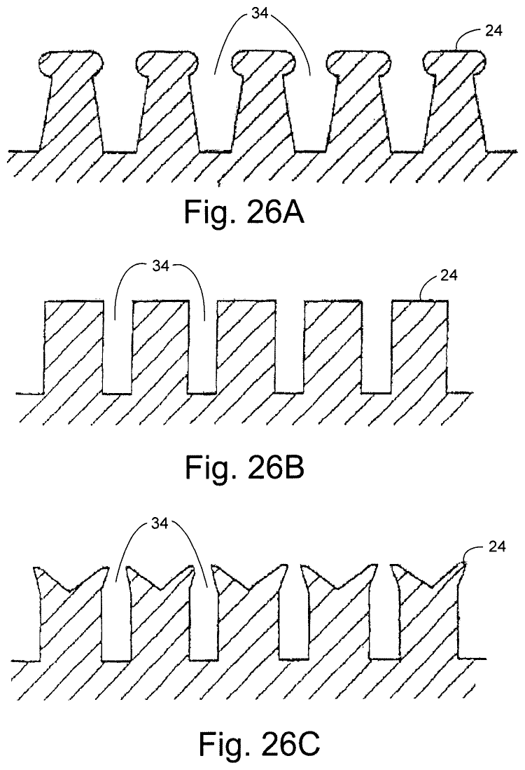

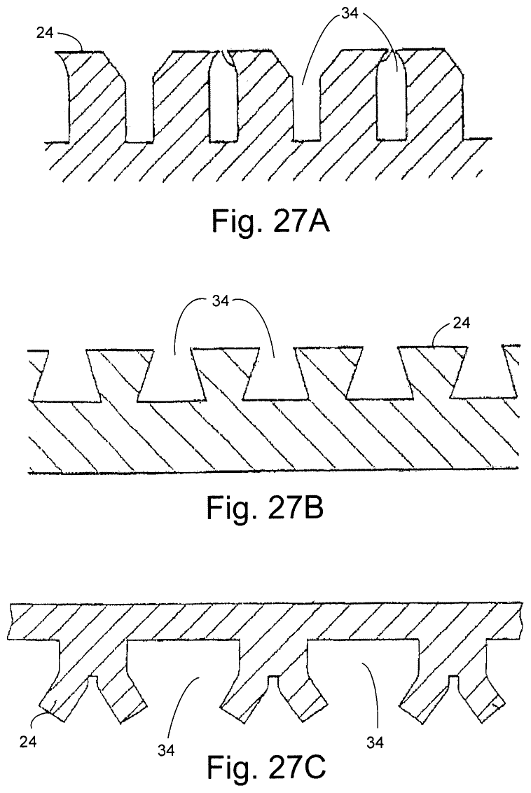

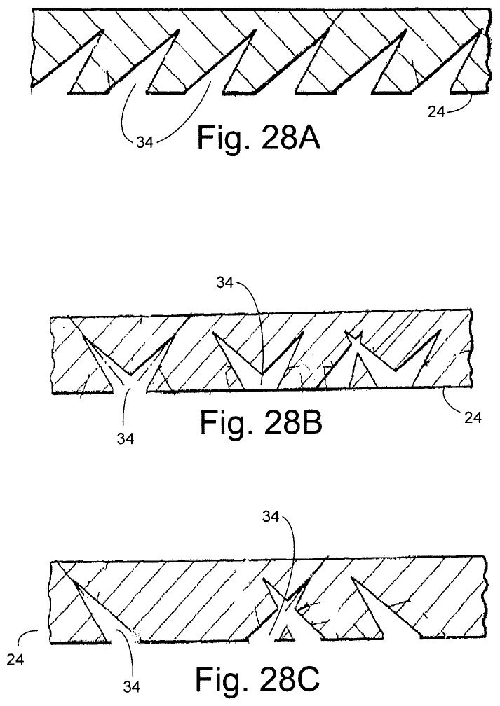

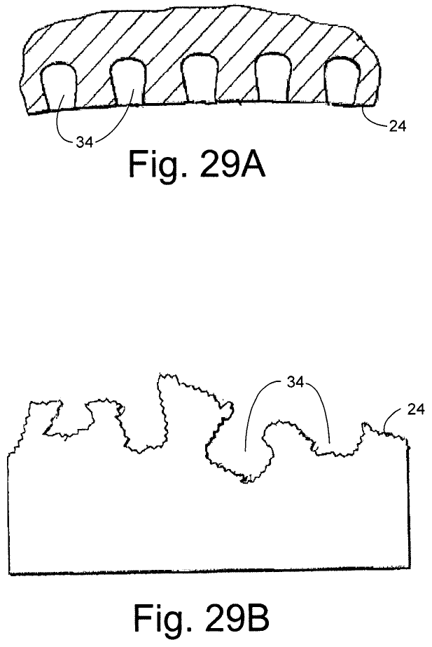

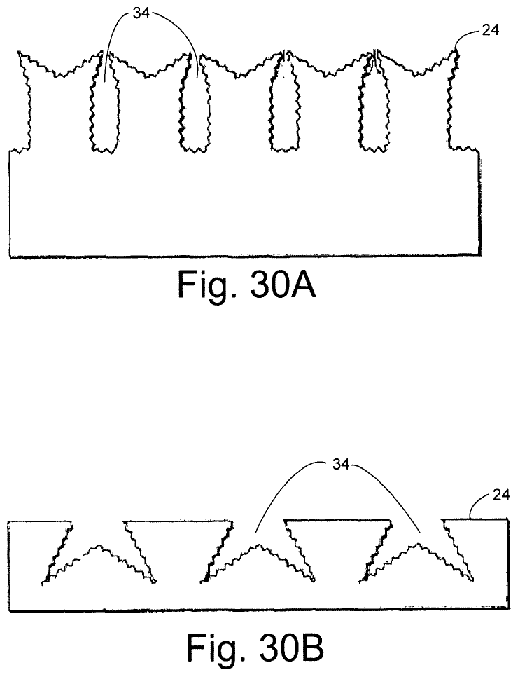

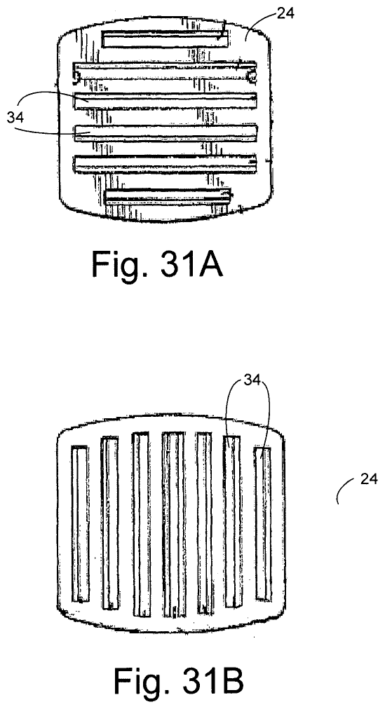

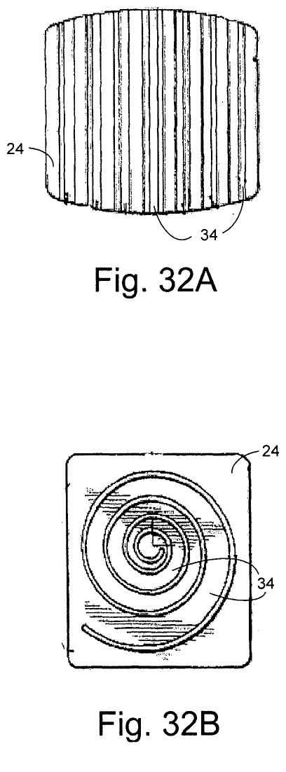

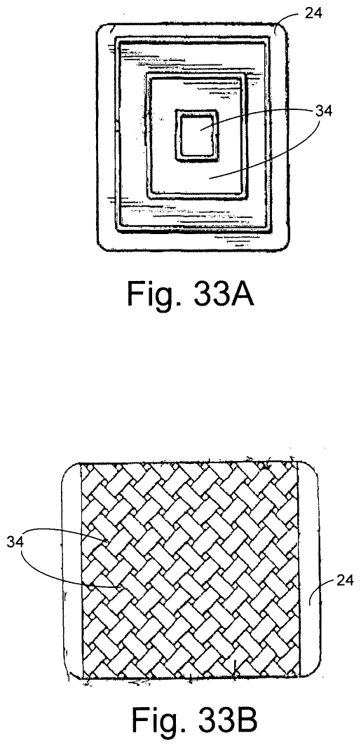

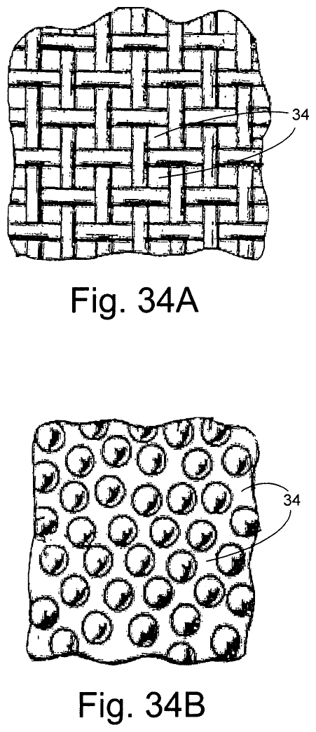

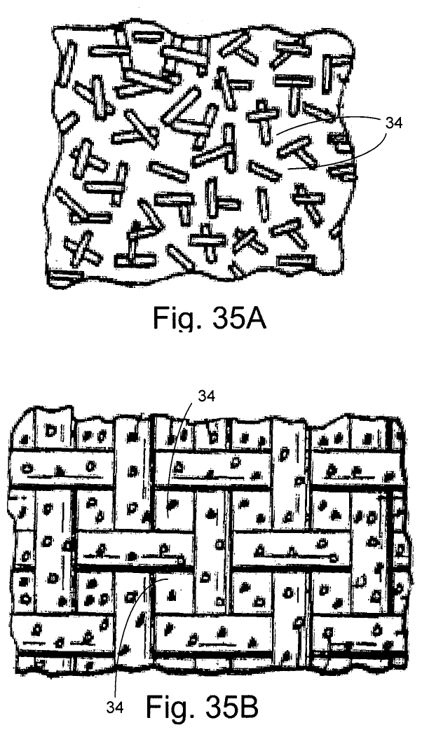

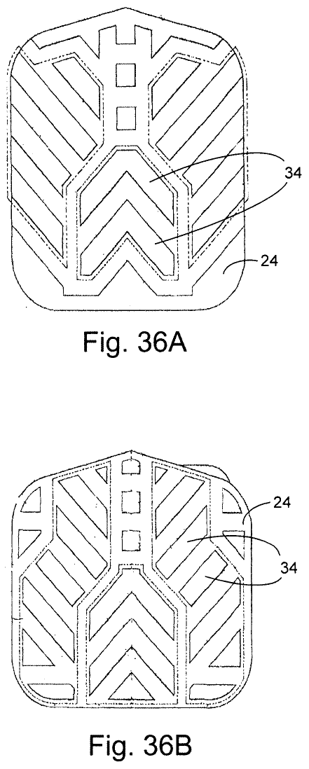

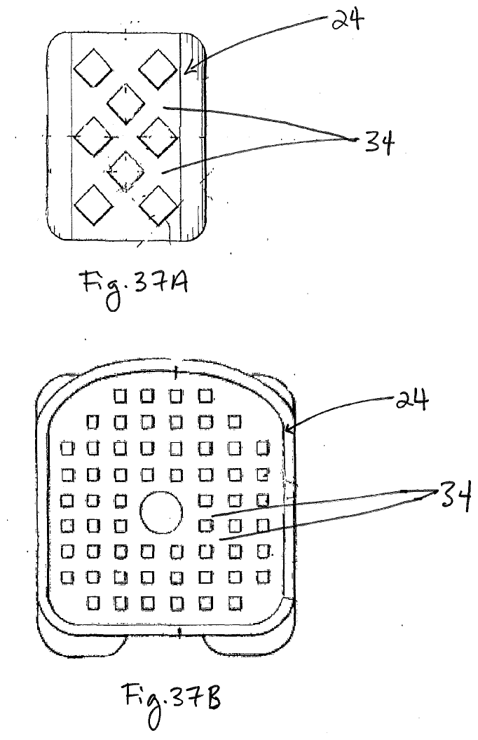

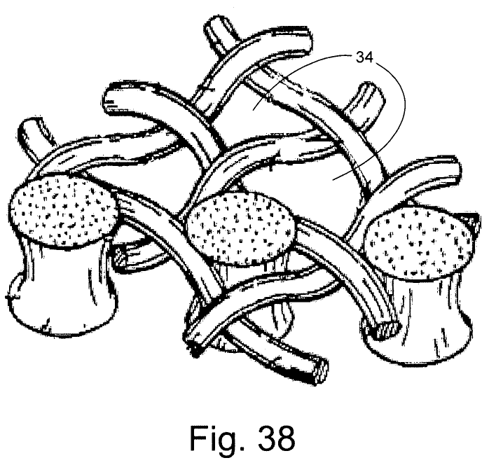

Orthodontic dental appliances in accordance with embodiments of the present invention are illustrated in FIGS. 1A-38. Turning to FIGS. 1A and 1B, an orthodontic dental appliance in accordance with an embodiment of the present invention is broadly designated by 10. The appliance 10 in this instance is an orthodontic bracket that has a base portion 12 and a body portion 14.

Although the appliance 10 depicted in FIGS. 1A and 1B is an orthodontic bracket, in accordance with the present invention, the appliance 10 may be any type of orthodontic dental appliance known to persons skilled in this art which is adhered to a tooth surface in conjunction with moving teeth or holding teeth in a particular position. Non-limiting examples of orthodontic dental appliances in accordance with the present invention include orthodontic brackets, buccal tubes, cleats, lingual buttons and the like or other devices that are directly bonded to a tooth surface.

The base portion 12 of the appliance 10 includes a mesial edge 16, a distal edge 18, a gingival edge 20 and an occlusal edge 22 and has a rear tooth abutting surface 24 for receiving adhesive, which is shaped to conform to the corresponding shape of the front surface of a tooth (not shown) to which the appliance 10 is affixed, and a front surface 26, opposite to the rear tooth abutting surface 24, which front surface 26, in one embodiment, may be substantially parallel to the rear tooth abutting surface 24 or, in another embodiment, may be substantially flat.

The rear tooth abutting surface 24 of the appliance 10 is adapted to attach the appliance 10 to the surface of a tooth by use of an adhesive. Any adhesive known to persons skilled in this art for adhering orthodontic dental appliances to teeth may be used in association with the appliances of the present invention, such as, for example, chemical cure or light cure adhesives, available from suppliers such as, for example, GAC Dentsply, Unitek, 3M and American Orthodontics. After preparing the surface of the tooth for direct bonding in any manner well-known to persons skilled in this art, the orthodontist applies appropriate adhesive to the tooth abutting surface 24 of the appliance 10, which is then fixed directly to the tooth.

The body portion 14 of the appliance 10 projects out from the front surface 26 of the base portion 12 and may or may not be integral with the base portion 12, as will be further discussed below. The body portion 14 may include two gingival tie wings 28 and two occulsal tie wings 30 which define an archwire slot 32 for receiving a typical orthodontic archwire or similar restraining means (not shown), which the orthodontist applies for corrective purposes. The gingival tie wings 28 and occulsal tie wings 30 may include a top flange which prevents the archwire secured around the base of the gingival tie wings 28 and occulsal tie wings 30 from slipping off. Thus, the gingival tie wings 28 and occulsal tie wings 30 can be useful as anchors for the archwire.

In an embodiment of the present invention, the base portion 12 and the body portion 14 can be integrally formed, or, alternatively, can be formed separately and subsequently attached together. If the base portion 12 and body portion 14 are made separately from each other, they may be made of the same or different materials and may be joined by any means known to persons skilled in this art, such as, for example, by welding, gluing or by a positive fit (e.g., a screw connection). In aspects, the base portion 12 and the body portion 14 may be shaped for mating with one another in one definite position, such as, for example, one may have the negative shape of the other.

In accordance with the present invention, the base portion 12 is provided with at least one cavity 34 formed in the rear tooth abutting surface 24 thereof. The at least one cavity 34 extends from the rear tooth abutting surface 24 into the thickness of the base portion 12, toward, but not protruding all the way through, the exposed front surface 26 of the base portion 12. The at least one cavity 34 may extend from the rear tooth abutting surface 24 into the thickness of the base portion 12 any depth known to persons skilled in this art that still maintains the integrity and strength of the base portion 12, as will be discussed in further detail below. The at least one cavity 34 is defined by cavity sides 36 and a cavity bottom 38, collectively termed the cavity walls.

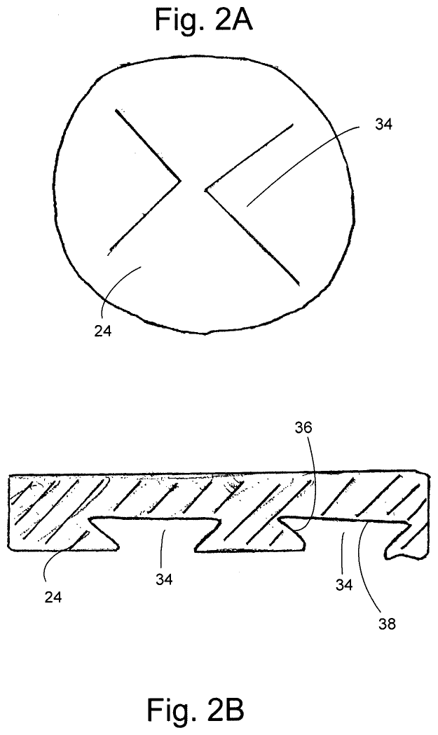

As shown in FIGS. 2A-38, the tooth abutting surface 24 of the appliance 10 comprises at least one adhesive receiving cavity 34. In embodiments of the present invention, the tooth abutting surface 24 comprises a plurality of adhesive receiving cavities 34. In embodiments of the present invention wherein the tooth abutting surface 24 comprises a plurality of cavities 34, the tooth abutting surface 24 may comprise any number of cavities known to persons skilled in this art that still maintain the integrity and strength of the base portion 12. In embodiments of the present invention wherein the tooth abutting surface 24 comprises a plurality of cavities 34, each cavity 34 of the plurality of cavities 34, may extend from the rear tooth abutting surface 24 into the thickness of the base portion 12 the same distance or different distances. Likewise, some cavities 34 may extend the same distance into the tooth abutting surface 24 while other cavities 34 may extend different distances.

The cavities 34, depending on the depth and number, provide varying degrees of porosity to the base portion 12 by which the adhesive can permeate into the base portion 12.

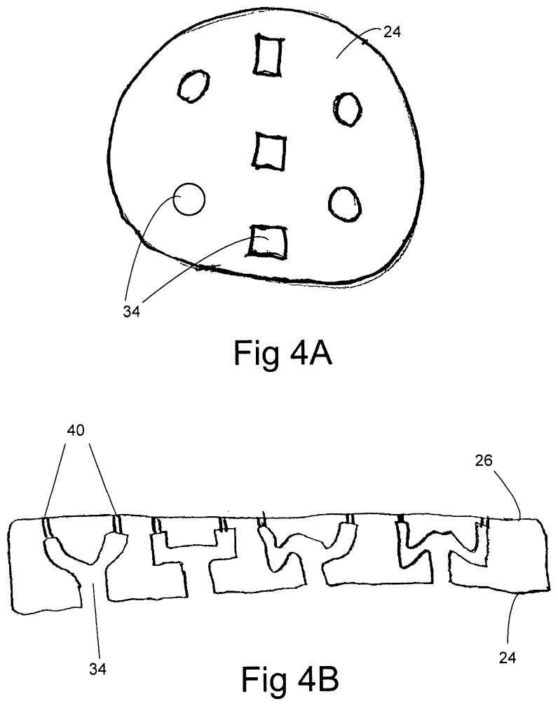

The at least one cavity 34 or plurality of cavities 34 can have any shape known to persons skilled in this art that achieves the purpose of allowing the adhesive to penetrate into the base portion 12. The porous geometry of the at least one cavity 34 or plurality of cavities 34, imparts various strengths, surface areas, and/or other characteristics to the base portion 12. For example, these porous geometries can be used to control the shape, type, degree, density, and size of porosity within the structure of the base portion 12. In some embodiments, such porous geometric designs can be of a regular shape, such as, for example, circular, triangular, square, rectangular, dodecahedral, octahedral, tetrahedral (diamond), as well as many other various geometric shapes. In other embodiments, the porous geometries of the present invention may be configured to have irregular shapes where various sides and dimensions have little, if any, repeating sequences. In some embodiments, the porous geometry may assume a single geometry, such as, for example, in FIGS. 2A, 2B, 3A, 3B, 10A, 10B, 11A, 11B, 12B, 13A, 13B, 14A, 14B, 15A, 15B, 16, 17A, 17B, 18A, 20A, 20B, 21A, 22A, 22B, 23B, 24A, 24B, 25A, 25B, 25C, 26A, 26B, 26C, 27B, 27C, 28A, 29A, 30A, 30B, 31A, 31B, 32A, 33A, 33B, 34A, 37A and 38. In other embodiments, the porous geometry may assume a combination of any number of different geometries, such as, for example, in FIGS. 4A, 4B, 5A, 5B, 6A, 6B, 7, 8A, 8B, 9A, 9B, 12A, 19A, 21B, 23A, 24C, 27A, 28B, 28C, 29B, 32B, 34B, 35A, 35B, 36A, 36B and 37B). In comparison, certain porous geometries may have different mechanical performance than other porous geometries.

In some embodiments, the porous geometry of the present invention defines a cavity 34 that is smaller in dimension at the tooth abutting surface 24 than the dimensions of the internal cavity formed therein. In other embodiments, the porous geometry defines a cavity 34 that is larger in dimension at the tooth abutting surface 24 than the dimensions of the internal cavity formed therein. In still other embodiments, the internal size dimensions of the cavities 34 may alternate between smaller than, or larger than, the dimensions of the cavities 34 at the tooth abutting surface 24. In aspects, the alteration between smaller and larger cavities may be in a random sequence or a uniform sequence depending on the requirements of the appliance 10.

As discussed above, the porous geometry of the present invention provides for varying degrees of cavity depth, such as deep or shallow cavities 34. It is also contemplated that the depths of the cavities 34 can alternate. In aspects, these alternating cavity depths are created in a random orientation. In aspects, these alternating cavity depths are created in a uniform orientation.

In an embodiment, the spacing between the cavities may be uniform. In another embodiment, the spacing between the cavities may be random. In an embodiment, the spacing between the pores is from about 0.005 inches to about 0.020 inches.

It is contemplated that the tooth abutting face 24 may have regularly sized cavities and regularly spaced cavities. It is also contemplated that the tooth abutting surface 24 may have irregularly sized cavities in an irregularly spaced configuration. It is further contemplated that the tooth abutting surface 24 may have regularly sized cavities arranged in an irregularly spaced configuration.

In an embodiment, the orthodontic appliance 10 may have a gradient porosity. For example, the tooth abutting surface 24 may be very porous and as one moves away from the tooth abutting surface 24 into the base portion 12, the porosity may alter such that the porosity is increased or decreased, even until the porosity is almost zero. In aspects, the base portion 12 may be comprised of different layers having different gradients of porosity. For example, the tooth abutting surface 24 may having a porosity of about 80%, whereas another portion of the base portion 12 may have a porosity of about 50%. Of course, the present invention contemplates a situation where the porosity of the base portion 12 alters from position to position depending on the requirements of the appliance 10.

In some embodiments, the at least one cavity 34 formed in the rear tooth abutting surface 24 of the base portion 12 forms at least one protrusion, peg, projection and/or overhanging portion. The at least one protrusion, peg, projection and/or overhanging portion may have a root or stem section having a base integrally formed with the tooth abutting surface 24 and a head or apex section buccolingually extending from the root/stem section. As may be appreciated, each protrusion, peg, projection and/or overhanging portion may, on its own, present an undercut, or may be further deformed at its outer extremity, thereby forming an undercut, proximate the outer extremity, which undercut is adapted to receive adhesive, that once cures or hardens, forms a mechanical bond or interlock between the appliance 10 and the adhesive.

The terms “projection”, “protrusion”, “peg”, “projection” and “overhanging portion”, as used herein are used interchangeably and refer to any structure which extends outwardly from the tooth abutting surface 24 of the base portion 12 of the appliance 10. The at least one projection may take any regular or irregular shape or configuration known to persons skilled in this art and make take a variety of shapes and configurations so long as it does not substantially offset the structural integrity of the appliance 10.

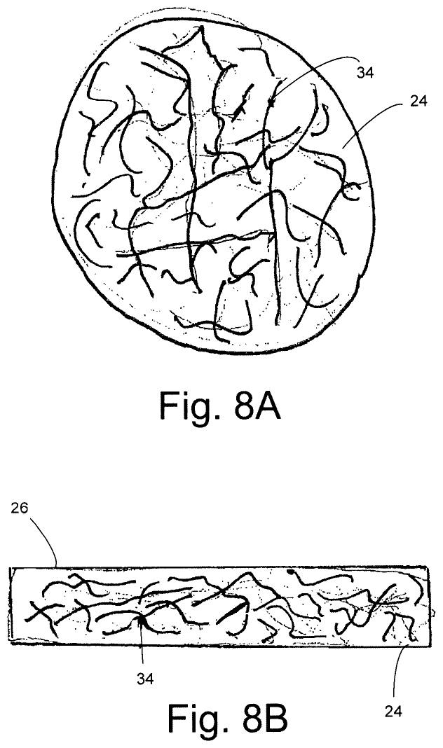

As shown in FIGS. 8A, 8B, 9A, 9B, 17A, 17B, 18A, 33B, 34A, 35B and 38, the at least one cavity 34 is a plurality of cavities 34 in the form of a lattice structure. As shown in FIGS. 8A and 8B, the lattice configuration may be random. As shown in 9A, 9B, 17A, 17B, 18A, 33B, 34A, 35B and 38, the lattice configuration may be uniform. In aspects, the lattice configuration may be a combination of both random and uniform.

In an embodiment, the lattice structure may allow for the use of stronger adhesives as they may not rely on the bond between the adhesive and the appliance 10, but instead, may trap the appliance 10 and may only rely on the bond between the adhesive and the tooth. This may allow for penetration of the adhesive into the entire structure creating a stronger bond of the appliance 10 with the tooth by distributing the mechanical forces in all directions.

In the embodiments described herein, the lattice structure may provide for sufficient porosity (open area) so that the adhesive may be allowed to flow freely and virtually unrestricted through the appliance 10 to the tooth. Free flow of the adhesive may affect the ultimate bond strength between the appliance 10 and the tooth through increased grip. The adhesive is able work its way through the cavities 34 and may improve the displacement of forces about the tooth.

Advantageously, the lattice structures described herein may allow for the adhesive to flow around it before it is cured. This may strengthen the bond as it may not rely only on the bond between the appliance 10 and the adhesive, but the structure of the adhesive may encapsulate the appliance 10 as well. The lattice structure is strong and may transmit external forces in multiple directions to the adhesive and may lessen its ability to break the bond. Improved bonding properties may reduce the necessity for multiple orthodontic appointments.

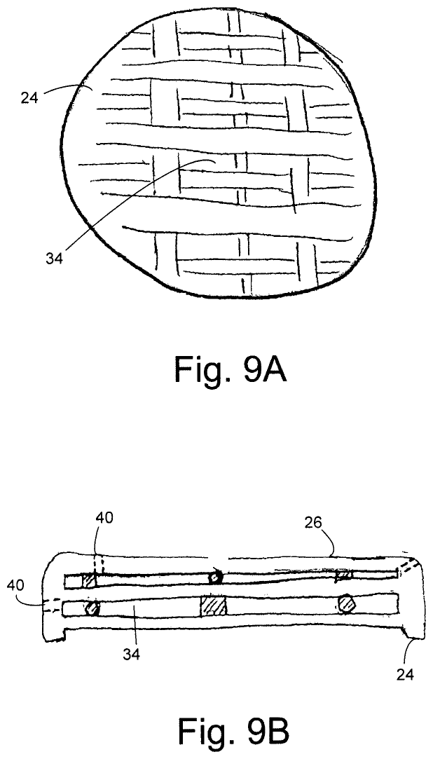

As shown in FIGS. 9A and 9B, the lattice structure may be in the form of a round or square mesh structure. In aspects, the strands of the lattice are angled at about 90° to each other. In other aspects, the strands of the lattice are angled at about 10°, about 15°, about 20°, about 25°, about 30°, about 35°, about 40°, about 45°, about 50°, about 55°, about 60°, about 65°, about 70°, about 75°, about 80°, or about 85° to each other.

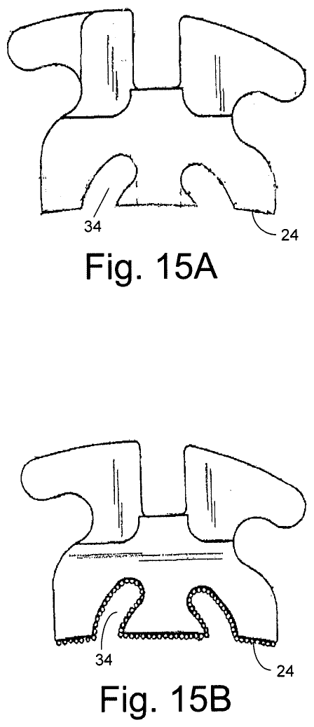

In an embodiment of the present invention, the tooth abutting surface 24, including the at least one cavity 34 and/or the at least one projection, may be given an additional treatment, such as, for example, roughening, etching or scribing, a plasma treatment, a coating, such as, for example, a primer treatment or coated with a layer of particles, or by deforming the at least one projection in the lateral direction, in an effort to further enhance adhesion (see for example, FIGS. 15B, 16, 29B, 30A, 30B, 34B, 35A, 35B and 38).

In some embodiments, at least a portion of the base portion 12 of the appliance 10 is substantially permeable to air but substantially impermeable to adhesive. In some embodiments, the entire base portion 12 of the appliance 10, is substantially permeable to air but substantially impermeable to adhesive. The at least a portion of the base portion 12 that is substantially permeable to air and substantially impermeable to adhesive is configured to allow air to permeate through the base portion 12 when the appliance 10 is being adhered to the tooth. The portion of the base portion 12 that is substantially permeable to air and substantially impermeable to adhesive functions as a “vent” to enable air trapped in air pockets within the adhesive to escape. The vent, while enabling air to move through at least a portion of the base portion 12, hinders or substantially prevents movement of the adhesive through the base portion 12 as the appliance 10 is placed on the tooth surface, such that the necessity of clean-up of adhesive near the front surface 26 of the base portion 12 is avoided.

The at least a portion of the base portion 12 that is substantially permeable to air but substantially impermeable to adhesive can be formed by any suitable method known to persons skilled in this art, such as, for example, by way of the material used for the at least a portion of the base portion 12 that is substantially permeable to air but substantially impermeable to adhesive or by way of forming the at least a portion of the base portion 12 that is substantially permeable to air but substantially impermeable to adhesive in the base portion 12.

In some embodiments, the base portion 12 comprises a single vent which is substantially permeable to air but substantially impermeable to adhesive. In some embodiments, the base portion 12 comprises enough vents to result in substantially the entire base portion 12 substantially permeable to air but substantially impermeable to adhesive.

In some embodiments, the vent/vents is/are a hole/holes or a pore/pores, the cross section of at least a portion thereof is large enough to allow air to pass therethrough,thus making at least a portion of the base portion 12 substantially permeable to air but small enough to prevent adhesive from passing therethrough, thus making the base portion 12 substantially impermeable to adhesive.

In some embodiments, the cross-sectional shape of the vent/vents is such that adhesive is prevented from passing therethrough, thus making the base portion 12 impermeable to adhesive but allows air to pass therethrough, thus making at least a portion of the base portion 12 substantially permeable to air.

In some embodiments, the path of the vent/vents through at least a portion of the base portion 12, is such, for example, but not limited to, tortuous, that adhesive is prevented from passing therethrough, thus making the base portion 12 impermeable to adhesive but allowing air to pass therethrough, thus making at least a portion of the base portion 12 substantially permeable to air.

In some embodiments, the portion of the base portion 12 that is substantially permeable to air and substantially impermeable to adhesive is comprised of a material that is substantially permeable to air and substantially impermeable to adhesive.

In some embodiments, the portion of the base portion 12 that is substantially permeable to air is at least one passageway 40 that extends from said tooth abutting surface 24 to said opposite front surface 26. For example, as shown in FIGS. 4B, 5B, 6B, 9B, 18B and 19A, the tooth abutting surface 24 further comprises at least one passageway 40 that extends through the base portion 12 to the front surface 26. In some embodiments, the tooth abutting surface has a single passageway 40. In some embodiments, the tooth abutting surface 24 has a plurality of passageways 40. Since the presence of air bubbles in the adhesive may weaken the ability of the adhesive to bond the appliance 10 to the tooth, the passageways 40 are configured in such a way as to facilitate the escape of air trapped in pockets formed in the adhesive when the appliance 10 is applied to the tooth. In some embodiments, the at least one passageway 40 is located within the at least one cavity 34. In some embodiments, a plurality of passageways 40 are located within the at least one cavity 34. In some embodiments, the at least one passageway 40 follows a straight path. In some embodiments, the at least one passageway 40 follows a torturous path. In some embodiments, the at least one passageway 40 includes at least one tapered portion that decreases in cross-sectional area as said outer front surface 26 is approached. In some embodiments, the plurality of passageways 40 are arranged in an array. However, other arrangements and/or arrays are also possible. In some embodiments, the at least one passageway 40 integrally connects at least two cavities 34. In some embodiments, the at least one passageway 40 comprises at least one additional passageway extending at an angle relative to the direction of extension of the at least one passageway 40 wherein the at least one additional passageway is substantially permeable to air and substantially impermeable to adhesive. In some embodiments, the at least one additional passageway extends in a direction perpendicular to the direction of extension of the at least one passageway 40. In some embodiments, the at least one passageway 40 extends through a central portion of the base portion 12. Moreover, the passageways 40 may extend in other portions of the base portion 12, including side portions or alternatively portions that extend along the entire periphery of the base portion 12, if desired. The at least one passageway 40 and the at least one additional passageway may be formed by any method known to persons skilled in this art, such as, for example, by drilling, stamping, casting or by additive manufacturing such as 3D printing.

In some embodiments, the at least one passageway 40 contains an element extending in the at least one passageway 40 that is substantially permeable to air and substantially impermeable to adhesive. In some embodiments, the element closes at least a portion of the at least one passageway 40. In some embodiments, the element is fixed in the at least one passageway 40. In some embodiments, the element is removable from the at least one passageway 40. The element may be made from any material that is substantially permeable to air and substantially impermeable to adhesive known by persons skilled in this art and may be inserted into the at least one passageway 40 by any method known by persons skilled in this art, such as, for example, but not limited to, injecting. In some embodiments, the element may be a liquid, a semi-solid such as a gel or a solid when inserted into the at least one passageway 40. In some embodiments, the element may become a semi-solid or solid within the at least one passageway over time or upon curing. In some embodiments, the element may be made of In embodiments of the present invention, the at least a portion of the base portion that is selectively permeable or semi-permeable may be composed of silicone; rubbers; elastomers; cork; ceramics; polyethylene (PE) such as, for example, but not limited to, high density spun-bound polyethylene similar to that sold under the name Tyvek™; polypropylene (PP) such as, for example, but not limited to, spun-bonded polypropylene fiber similar to that sold under the name Typar™; microperforated polyethylene similar to that sold under the name Rufco-Wrap™; polytetrafluoroethylene (PTFE or Teflon™) such as, for example, but not limited to, stretched polytetrafluoroethylene similar to that sold under the name Gore-Tex™; a silanized alumina; a molecular sieve material such as, for example, but not limited to, zeolites (aluminosilicate minerals), porous glass, active carbon, and clays; and a hydrophobic aerogel such as, for example, but not limited to, those based on silica, alumina, chromia, titania, zirconia, vanadia, samaria, holmia, erbia, carbon, cadmium selenide quantum dots, metal oxides such as, for example, but not limited to, aluminum oxide, tin dioxide, iron oxide, neodymium oxide, organic polymers such as, for example, but not limited to, agar or cellulose, and chalcogens (chalcogel) such as, for example, but not limited to, sulfur, selenium and other elements. The appliance 10 of the present invention may be made of any suitable material known to persons skilled in this art for its intended purpose, such as metals (e.g., stainless steel and titanium), ceramics (e.g., mono- or poly-crystalline alumina), plastics (e.g., filled and/or reinforced polycarbonate), porcelain, glass etc. It is contemplated that the appliance 10 can cover as much or as little of the tooth that is necessary, dependent on, for example, the size, shape and location of the tooth. It will be appreciated that a wide variety of appliance configurations are suitable in the practice of the present invention.

In an embodiment, the appliance 10 may be made of any suitable metal powder. The metal powder may be titanium alloys, stainless steel, cobalt chromium alloys, tantalum or niobium. It contemplated that the orthodontic appliance 10 may be made of any combination of the metal powders described above. In an embodiment, the metal powder is tantalum. The material, such as tantalum, used in these appliances is essentially inert to adhesives and body fluids so that chemical bonding, dissolution, discoloration, or degradation of the lattice structure does not occur.

It is contemplated that different metals can be used for the base portion 12 and the body portion 14, for example to provide a relatively hard body portion 14 for durably holding the archwire and to provide a softer base portion 12 to prevent the appliance 10 from breaking upon exposure of mechanical forces (for example during chewing action). Alternatively, the base portion 12 and the body portion 14 may be made of the same metal.

It is contemplated that appliance 10 may have a variety of possible prescriptive values of torque, tip, and angulation. For example, in one embodiment the appliance 10 can have an archwire slot that extends along an axis which is inclined by about 5 degrees relative to the longitudinal axis. Typically, the archwire slot can extend along an axis which is inclined by about 10, about 15, about 20, about 25, about 30, about 35, about 40, about 45, about 50, about 55, about 60, about 65, about 70, about 75, about 80, about 85 or about 90 degrees relative to the longitudinal axis.

The orthodontic appliances described herein can be made by any means known to persons skilled in this art. For example, conventional methodologies used for producing orthodontic appliances include, but are not limited to, investment casting, metal or ceramic injection molding, extrusion cutting or machining.

In an embodiment, the orthodontic appliance 10 is made by rapid prototyping or additive manufacturing (e.g., 3D printing). This typically involves producing the component by progressively adding or subtracting layers of material for direct or indirect fabrication. Fabrication is direct if it is performed notably by laser sintering; indirect if it is performed notably by the lost wax casting method. Using this method, a single customized appliance 10 may be produced more quickly than by machining or by some other method that calls for specialist tooling.

Production of the orthodontic appliance 10 using laser sintering and/or laser melting permits extensive automated production thereof, since a computer-aided laser is able to generate predefined shapes. The predefined forms are firstly determined with the help of a computer. Data obtained by scanning the patient's teeth or a dental cast of the patient's teeth are used as a basis for determining the optimal form of the orthodontic appliance 10. Furthermore, this method allows complex structures of virtually any shape and size to be produced. This method is particularly suitable in that complex porous geometries of the orthodontic appliance 10 can be easily produced.

In an embodiment, the tooth abutting surface 24 of the customized orthodontic appliance 10 is typically overall shaped to conform to a portion or area of the outer tooth surface. Typically, the tooth abutting surface 24 of the customized orthodontic appliance 10 has a footprint (or outer periphery) and the portion of the outer tooth surface corresponds in size and shape to that footprint. The term “conform” as used herein denotes that the overall shape of the tooth abutting surface 24 and the overall shape of the tooth portion correspond to each other, although a surface structure of the tooth abutting surface 24 may be different from the surface structure of the tooth. For example, the tooth abutting surface 24 comprises the at least one cavity 24 but still overall conforms to the shape of the tooth portion.

In an embodiment, the base portion 12 is made by additive manufacturing. In another embodiment, the body portion 14 is made by additive manufacturing. In another embodiment, both the base portion 12 and body portion 14 are made integral with one another through the use of additive manufacturing. In an embodiment, both the base portion 12 and the body portion 14 are initially pre-manufactured and subsequently joined, for example by assembly. The pre-manufactured body portion 14 typically has a base portion interface in the form of a surface for connection of the body portion 14 with the base portion 12. The base portion 12 and the body portion 14 may be joined by any known means of the art.

In a further embodiment, the method comprises the step of building up the base portion 12 on the body portion 14. The pre-manufactured body portion 14 also typically has a base portion interface in the form of a surface for connection of the body portion 14 with the base portion 12. The base portion interface is typically arranged opposite of the archwire slot. Further, the base portion interface is typically used in this embodiment for building up the base portion 12 thereon by a material build-up process.

In an embodiment, the method may further comprise the step of providing a primer layer on the body portion 14, in particular on the base portion interface of the body portion 14, and building up the base portion 12 on the primer layer. The primer layer may comprise a metal alloy and a flux melting agent. Thus, using for example Selective Laser Melting (SLM), a stable connection between the base portion 12 and the body portion 14 may be achieved.

In an embodiment, the method further comprises the steps of providing a plurality of differently shaped pre-manufactured physical body portions 14. Further, the step of providing the pre-manufactured physical body portions 14 according to the invention may comprise selecting a particular pre-manufactured physical body portion 14 out of the plurality of differently shaped pre-manufactured physical body portions 14 (e.g., body portions 14 having any of a variety of possible prescriptive valves of torque, tip and angulation) as herein described. Typically, the material build-up process is based on Selective Laser Melting (SLM), in particular Direct Metal Laser Sintering (DMLS).

It is also contemplated that the method may further comprise steps for determining the shape of the appliance 10 and in particular for determining the shape of the tooth abutting surface 24. The shape of the appliance 10 and/or the shape of the tooth abutting face 24 may be provided in a computer processible format and used in the material build-up process to make the appliance 10/tooth abutting face 24.

In an embodiment, a virtual model of the patient's dentition (upper and/or lower jaw) with the teeth in the initial positions may be obtained from scanning the actual teeth of the patient intra-orally, or from scanning a physical model (for example a plaster model cast from a dental impression) of the patient's teeth. In aspects, it is further possible to scan a dental impression taken from the patients teeth. The shape of the patient's dentition may be captured in the form of a three-dimensional computer model, referred to as a “virtual malocclusion model”.

An advantage of the method according to the present invention is thus first of all that a plastic tooth model is not necessary. If such a tooth model already exists, however, or is possibly produced for better visualization, this can likewise be used according to the present method described herein.

Typically, an area is identified on several of the patient's teeth within the virtual model. The identified area or a copy thereof may be used to define a virtual bonding surface of the appliance 10. In aspects, an area may be identified on the labial or lingual surface of individual teeth in the model. Such area is a representation of a physical area on a tooth on which a tooth abutting surface 24 of the appliance 10 may be bonded. Typically, the area is selected to be large enough to cover a sufficient area so that an orthodontist can place the appliance 10 on the corresponding tooth in one definite position. Typically, the area further covers approximately about 60 to about 75 percent of the labial or lingual surface of a tooth to provide both good adhesion and to facilitate correct positioning.

The skilled person will recognize that this can be done by computer operation, for example by Computer Aided Design (CAD) software allowing creation and manipulation of three-dimensional computer models. Further, the skilled person will recognize that the mentioned areas can be identified physically on the patients teeth or the model of the patient's teeth and captured to provide the virtual bonding surface.

Typically, the CAD system allows the tooth abutting surface 24 to be designed based on the determination of the virtual bonding surface. For example, the virtual bonding surface (or a copy thereof) may be used to form the shape of the tooth abutting surface 24 of the appliance 10 and an offset of the virtual bonding surface may be used as a rear side or outward-facing side (opposite of the tooth facing side) of the tooth abutting surface 24. A so formed computer design may be exported in the form of computer processible data to a material build-up device, for example an SLM device, in which the appliance 10 is completed as described above.

In an embodiment, the body portion 14 is placed in a three-dimensional material build-up device such as a Selective Laser Melting (SLM) device. Typically, the body portion 14 is placed at a determined reference position. Typically, the reference position comprises information about a position of the body portion 14 in a coordinate system of the device as well as an orientation of the body portion 14 in that coordinate system. In aspects, the body portion 14 is embedded in a metal powder, such as tantalum, with the base portion interface oriented toward the free surface of that powder. A thin layer of powder covers the base portion interface and a laser beam is used to sinter the base portion 12 layerwise onto the body portion 14. The positioning of the laser beam is computer numerically controlled in accordance with the virtual model of the base portion 12 and in appropriate geometric relationship to the body portion 14.

In aspects, the base portion 12 may be integrally formed with the body portion 14 during the additive manufacturing process. For example, the base portion 12 and the body portion 14 are staged and built up at the same location (e.g., generally the same x- and y-axis location) on the base plate. In aspects, the base portion 12 may be formed separately from the body portion 14 during the additive manufacturing process. For example, the base portion 12 is staged and built up at one location in the additive manufacturing system whereas the body portion 14 is staged and built up at another location on the base plate. The base portion 12 and the body portion 14 are then later joined together using methods known in the art.

In an embodiment, the method produces an orthodontic appliance 10, wherein the tooth abutting surface 24 has at least one adhesive receiving cavity 34. In another embodiment, the method produces an orthodontic appliance 10, wherein the tooth abutting surface 24 has a plurality of adhesive receiving cavities 34. In another embodiment, the method produces an orthodontic appliance 10 that is substantially porous. In another embodiment, the method produces an orthodontic appliance 10 that is completely porous.

In another embodiment, the method produces an orthodontic appliance 10, wherein each of the porosity, pore size and pore volume of the tooth abutting surface 24 is uniformly spaced on the tooth abutting surface 24. In another embodiment, the method produces an orthodontic appliance 10, wherein each of the porosity, pore size and pore volume is irregularly spaced on the tooth abutting surface 24. In aspects, the method produces an orthodontic appliance 10 having a gradient porosity as herein described. In aspects, the method produces an orthodontic appliance 10, wherein the tooth abutting surface 24 has a pore size as herein described. In aspects, the method produces an orthodontic appliance 10, wherein the tooth abutting surface 24 has a porosity as herein described. In aspects, the method produces an orthodontic appliance 10, wherein the tooth abutting surface 24 has a pore volume as herein described. In aspects, the method produces an orthodontic appliance 10, wherein the at least one adhesive receiving cavity 34 has a lattice configuration as herein described. In aspects, the method produces an orthodontic appliance 10, wherein the plurality of adhesive receiving cavities 34 have a lattice configuration as herein described.

The orthodontic appliance 10 can be manufactured using casting, metal injection molding, micromachining, any combination of generic mass production and customization techniques, and/or any direct digital manufacturing technique and by building up the material by additive methods, such as three-dimensional printing (“3D printing”), which can include, for example, rapid prototyping.

3D printing (additive manufacturing) may be capable of producing stronger, more effective, and less expensive orthodontic appliances. Using this technology, the orthodontic appliance 10 of the present invention can be structured in lattices rather than solid pieces of metal, thereby improving fit, reducing weight and the comfort level experienced by the patient. Furthermore, a clear benefit of this technology is that the patient would be able to have tailor-made brackets by scanning their teeth and matching it with a metal 3D-printed replacement.

It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

1. An orthodontic appliance comprising: a base portion having a tooth abutting surface and an opposite outer surface, said tooth abutting surface for adhering to a tooth; a body portion extending from said base portion in a direction away from said outer surface, said body portion for receiving an archwire; said base portion comprising at least one cavity for accommodating an adhesive and forming a lock between said appliance and said adhesive when said adhesive cures, said at least one cavity extending into said base portion away from said tooth abutting surface toward, but not through to, said opposite outer surface; wherein at least a portion of said base portion is substantially permeable to air and substantially impermeable to said adhesive and is configured to allow air to permeate through said base portion when said appliance is being adhered to said tooth.

2. The orthodontic appliance according to claim 1, wherein said at least one cavity decreases in dimension in a direction away from said tooth abutting surface.

3. The orthodontic appliance according to claim 1, wherein said at least one cavity increases in dimension in a direction away from said tooth abutting surface.

4. The orthodontic appliance according to claim 1, wherein said at least one cavity comprises a substantially circular depression in said tooth abutting surface.

5. The orthodontic appliance according to claim 1, wherein said at least one cavity has at least one pore through which excess adhesive may flow when the appliance is being adhered to said tooth.

6. The orthodontic appliance according to claim 1, wherein said at least one cavity is a plurality of cavities.

7. The orthodontic appliance according to claim 6, where said plurality of cavities are arranged longitudinally parallel in said tooth abutting surface.

8. The orthodontic appliance according to claim 6, wherein said plurality of cavities are arranged horizontally parallel in said tooth abutting surface.

9. The orthodontic appliance according to claim 6, wherein said plurality of cavities is provided by a mesh screen.

10. The orthodontic appliance according to claim 1, wherein said at least a portion of said base portion that is substantially permeable to air is at least one passageway that extends from said tooth abutting surface to said opposite surface.

11. The orthodontic appliance according to claim 10, wherein said at least one passageway is located in said at least one cavity.

12. The orthodontic appliance according to claim 10, wherein said at least one passageway includes at least one tapered portion that decreases in cross-sectional area as said outer surface is approached.

13. The orthodontic appliance according to claim 10, wherein said at least one passageway is tortuous.

14. The orthodontic appliance according to claim 10, wherein said at least one passageway contains an element extending in said at least one passageway that is substantially permeable to air and substantially impermeable to said adhesive.

15. The orthodontic appliance according to claim 14, wherein said element closes at least a portion of said at least one passageway.

16. The orthodontic appliance according to claim 14, wherein said element is fixed in said at least one passageway.

17. The orthodontic appliance according to claim 10, wherein said at least one passageway also extends through said body portion.

18. The orthodontic appliance according to claim 17, wherein said at least one passageway extends through a central portion of said body portion.

19. The orthodontic appliance according to claim 10, wherein said at least one passageway is a plurality of passageways.

20. The orthodontic appliance according to claim 10, said at least one passageway comprises at least one additional passageway extending at an angle relative to the direction of extension of said at least one passageway wherein said at least one additional passageway is substantially permeable to air and substantially impermeable to said adhesive.

21. The orthodontic appliance according to claim 20, wherein said at least one additional passageway extends in a direction perpendicular to the direction of extension of said at least one passageway.

22. The orthodontic appliance according to claim 1, wherein the appliance is a bracket, buccal tube, cleat or button.

23. The orthodontic appliance according to claim 1, wherein the appliance is made by 3D-printing.

24-33. (canceled)
